(19) United States
(12) Patent Application Publication
(10) Pub. No.: US 2009/0316262 A1
(43) Pub. Date: Dec. 24, 2009

(54) TRANSMISSION TYPE POLARIZING ELEMENT, AND COMPOSITE POLARIZING PLATE USING THE ELEMENT

(75) Inventors: Shigeo Kittaka, Tokyo (JP); Tatsuhiro Nakazawa, Tokyo (JP); Satoshi Tanaka, Tokyo (JP); Kazutomo Ikeuchi, Tokyo (JP); Keiji Tsunetomo, Tokyo (JP)

Correspondence Address: HAMRE, SCHUMANN, MUELLER & LARSON, P.C., P.O. BOX 2902, MINNEAPOLIS, MN, 55402-0902, US

(73) Assignee: Nippon Sheet Glass Company, Limited, Tokyo (JP)

(21) Appl. No.: 12/309,718

(22) PCT Filed: Jun. 26, 2007
(86) PCT No.: PCT/JP2007/062782

§ 371 Date: Jan. 27, 2009

(30) Foreign Application Priority Data
Aug. 9, 2006 (JP) 2006-217119
Feb. 13, 2007 (JP) 2007-031543

(51) Int. Cl. G02B 5/30

(52) U.S. Cl. 359/486

(57) ABSTRACT

A transmission type polarizing element 1 includes a dielectric substrate 3 having a structure in which a plurality of ridges 2 with an angle section are arranged parallel to each other on one side of the dielectric substrate 3, a thin film 4 that is made of a light absorbing substance and formed on the surfaces of the plurality of ridges 2 with an angle section, and a first dielectric substance layer 5 covering the surface of the thin film 4 that faces away from the dielectric substrate 3. When light is incident perpendicularly on the dielectric substrate 3, this transmission type polarizing element 1 transmits a TM polarizing component of the incident light whose magnetic field vibrates in the same direction as the longitudinal direction of the ridges 2 and absorbs a TE polarizing component of the incident light whose electric field vibrates in the same direction as the longitudinal direction of the ridges 2. Thus, a transmission type polarizing element that reduces return light, has high durability, and is capable of being used as a polarizing plate can be provided with a simple configuration.

### TECHNICAL FIELD

The present invention relates to a transmission type polarizing element that transmits one polarizing component of substantially parallel light, absorbs the other polarizing component different from the one polarizing component, and can be used as a polarizing plate, and also relates to a composite polarizing plate using the transmission type polarizing element.

### BACKGROUND ART

A polarizing plate that transmits only a specific polarizing component of incident light has been used widely for a liquid crystal display panel, a read/write head of an optical disk recording/reproducing apparatus, optical communications, etc.

FIG. 50 is a schematic view of an optical system of a liquid crystal projector. As shown in FIG. 50, light emitted from a light source 13 is divided into red, green, and blue wavelength components, and then become illumination light for individual liquid crystal display panels 14, 15, and 16. The images of the liquid crystal display panels 14, 15, and 16 are superimposed by a dichroic prism 17, and subsequently projected onto a screen or the like by a projection lens 18. In this case, an incident-side polarizing plate 19 for transmitting only one polarizing component of incident light and an emission-side polarizing plate 20 for transmitting only the other polarizing component of the incident light that is different from the one polarizing component are disposed respectively on both sides of each of the liquid crystal display panels 14, 15, and 16.

A polarizing plate used for a liquid crystal display panel is required to meet the following conditions: the ratio of the transmittance for one polarizing component to that for the other polarizing component (extinction ratio) is large; the transmittance for the polarizing component that passes through the polarizing plate is high; and return light caused by reflection from the emission-side polarizing plate is suppressed. This is because if the return light caused by reflection from the emission-side polarizing plate 20 shown in FIG. 50 reenters the liquid crystal display panel, it becomes stray light that may lower the contrast of an image. To reduce the return light caused by reflection from the emission-side polarizing plate 20, e.g., a structure capable of absorbing the energy of a non-transmitted polarizing component is necessary.

As an absorption type polarizing plate, a laminated polarizer in which directional organic films for absorbing the other polarizing component and extremely thin metal films are arranged at predetermined intervals (see, e.g., Tadao Tsuruta, “Pencil of Rays”, the third volume, New Technology Communications, Co., Ltd., p. 285, FIG. 23.7, 1993), a glass layer randomly including small acicular metals that are aligned in the same direction (POLARCOR manufactured by Corning Incorporated), a dielectric photonic crystal in which metal strips are arranged in many layers (see, e.g., JP 11 (1999)-237507), etc. have been known.

### DISCLOSURE OF INVENTION

### Problem to be Solved by the Invention

Although the directional organic film is inexpensive and therefore used widely for a liquid crystal display panel, it is likely to be degraded due to the irradiation of light. Such degradation of the directional organic film is conspicuous particularly for green light and blue light. The polarizing plate made of an inorganic material may have high durability. However, the laminated polarizer has to be formed by superimposing a large number of very thin layers. This increases the cost and also makes it difficult to produce a laminated polarizer having a large area. Moreover, it takes much time and effort to produce POLARCOR and the dielectric photonic crystal in which metal strips are arranged in many layers, and thus they are expensive.

With the foregoing in mind, it is an object of the present invention to provide a transmission type polarizing element that reduces return light and can be used as a polarizing plate with a simple configuration.

It is also an object of the present invention to provide a composite polarizing plate using the transmission type polarizing element to ensure a large extinction ratio.

### Means for Solving Problem

To achieve the above objects, a transmission type polarizing element of the present invention includes a dielectric substrate having a structure in which a plurality of ridges with an angle section are arranged parallel to each other on one side of the dielectric substrate, and a thin film that is made of a light absorbing substance and provided on the plurality of ridges with an angle section. When light is incident perpendicularly on the dielectric substrate, the transmission type polarizing element transmits a TM polarizing component of the incident light whose magnetic filed vibrates in the same direction as a longitudinal direction of the ridges and absorbs a TE polarizing component of the incident light whose electric field vibrates in the same direction as the longitudinal direction of the ridges.

In the above configuration of the transmission type polarizing element of the present invention, it is preferable that the surface of the thin film that faces away from the dielectric substrate is covered with a first dielectric substance layer.

In this case, it is preferable that the surface of the first dielectric substance layer that faces away from the dielectric substrate is a plane.

In this case, it is preferable that the surface of the first dielectric substance layer that faces away from the dielectric substrate has a shape that follows the angle section.

In this case, it is preferable that the first dielectric substance layer covering the surface of the thin film that faces away from the dielectric substrate is a dielectric multi-layer film having a shape that follows the angle section.

In the above configuration of the transmission type polarizing element of the present invention, it is preferable that the plurality of ridges with an angle section are of the same cross-sectional shape and are arranged parallel to each other at a constant period.

In the above configuration of the transmission type polarizing element of the present invention, it is preferable that a plurality of the thin films made of a light absorbing substance are disposed with a second dielectric substance layer interposed between them.

In the above configuration of the transmission type polarizing element of the present invention, it is preferable that a dielectric multi-layer film having a shape that follows the angle section is disposed between the thin film made of a light absorbing substance and the dielectric substrate.

A composite polarizing plate of the present invention includes a first transmission type polarizing element disposed on a light incident side and a second transmission type polarizing element disposed on a light emitting side. Only the first transmission type polarizing element of the first and second transmission type polarizing elements is the transmission type polarizing element of the present invention.

### EFFECTS OF THE INVENTION

The present invention can provide a polarizing plate that reduces return light and has a simple configuration by using an inorganic material. Thus, the polarizing plate of the present invention is superior in durability to a polarizing plate configured of an organic material.

### BRIEF DESCRIPTION OF DRAWINGS

FIG. 1 is a cross-sectional view showing a transmission type polarizing element in Embodiment 1 of the present invention.

FIG. 2 is a cross-sectional view showing a transmission type polarizing element in Embodiment 2 of the present invention.

FIG. 3 is a cross-sectional view showing a transmission type polarizing element in Embodiment 3 of the present invention.

FIG. 4 is a cross-sectional view showing a composite polarizing plate in Embodiment 4 of the present invention.

FIG. 5 is a cross-sectional view showing a transmission type polarizing element in Embodiment 5 of the present invention.

FIG. 6 is a cross-sectional view showing a transmission type polarizing element in Embodiment 6 of the present invention.

FIG. 7 is a cross-sectional view showing a transmission type polarizing element in Embodiment 7 of the present invention.

FIGS. 8A and 8B are cross-sectional views showing another example of a transmission type polarizing element in an embodiment of the present invention.

FIG. 9 is a cross-sectional view showing yet another example of a transmission type polarizing element in an embodiment of the present invention.

FIG. 10 is a cross-sectional view showing a transmission type polarizing element in Design examples 1 to 5 of the present invention.

FIGS. 11A and 11B are graphs showing a reflectance on the air side and a transmittance on the dielectric substrate side for TE polarized light and TM polarized light, respectively, in Design Example 1 of the present invention.

FIGS. 12A and 12B are graphs showing a reflectance on the air side and a transmittance on the dielectric substrate side for TE polarized light and TM polarized light, respectively, in Design Example 2 of the present invention.

FIGS. 13A and 13B are graphs showing a reflectance on the air side and a transmittance on the dielectric substrate side for TE polarized light and TM polarized light, respectively, in Design Example 3 of the present invention.

FIGS. 14A and 14B are graphs showing a reflectance on the air side and a transmittance on the dielectric substrate side for TE polarized light and TM polarized light, respectively, in Design Example 4 of the present invention.

FIGS. 15A and 15B are graphs showing a reflectance on the air side and a transmittance on the dielectric substrate side for TE polarized light and TM polarized light, respectively, in Design Example 5 of the present invention.

FIG. 16 is a cross-sectional view showing a transmission type polarizing element in Reference Examples 1 and 2 of the present invention.

FIGS. 17A and 17B are graphs showing a reflectance on the air side and a transmittance on the dielectric substrate side for TE polarized light and TM polarized light, respectively, in Reference Example 1 of the present invention.

FIGS. 18A and 18B are graphs showing a reflectance on the air side and a transmittance on the dielectric substrate side for TE polarized light and TM polarized light, respectively, in Reference Example 2 of the present invention.

FIG. 19 is a cross-sectional view showing a transmission type polarizing element in Design Example 6 of the present invention.

FIGS. 20A and 20B are graphs showing a reflectance on the air side and a transmittance on the dielectric substrate side for TE polarized light and TM polarized light, respectively, in Design Example 6 of the present invention.

FIGS. 21A and 21B are graphs showing a transmittance, a reflectance, and an absorptance for TM polarized light and TE polarized light, respectively, in Design Example 7 of the present invention.

FIGS. 22A and 22B are graphs showing a transmittance, a reflectance, and an absorptance for TM polarized light and TE polarized light, respectively, in Reference Example 3 of the present invention.

FIGS. 23A and 23B are graphs showing a transmittance, a reflectance, and an absorptance for TM polarized light and TE polarized light, respectively, in Design Example 8 of the present invention.

FIGS. 24A and 24B are graphs showing a transmittance, a reflectance, and an absorptance for TM polarized light and TE polarized light, respectively, in Design Example 9 of the present invention.

FIG. 25 is a cross-sectional view showing a transmission type polarizing element in Example 1 of the present invention.

FIG. 26 is a graph showing a transmittance and a reflectance for TM polarized light and TE polarized light in Example 1 of the present invention.

FIG. 27 is a cross-sectional view showing a transmission type polarizing element in Example 2 of the present invention.

FIG. 28 is an electron micrograph of the transmission type polarizing element in Example 2 of the present invention.

FIG. 29 is a graph showing a transmittance and a reflectance for TM polarized light and TE polarized light in Example 2 of the present invention.

FIG. 30 is an electron micrograph of a transmission type polarizing element in Example 3 of the present invention.

FIG. 31 is a graph showing a transmittance and a reflectance for TM polarized light and TE polarized light in Example 3 of the present invention.

FIG. 32 is a graph showing a transmittance and a reflectance for TM polarized light and TE polarized light in Example 4 of the present invention.

FIG. 33 is a graph showing a refractive index (n+ki) of a metal film of Nb in Design Example 10 of the present invention.

FIG. 34 is a graph showing a refractive index n of a Nb₂O₅ film (H layer) in Design Example 10 of the present invention.

FIG. 35 is a graph showing a refractive index n of a SiO₂ film (L layer) in Design Example 10 of the present invention.

FIG. 36A is a graph (where the incident angle θ is 0°) showing a transmittance and a reflectance for TM polarized light and TE polarized light, and FIG. 36B is an enlarged graph showing a part of the reflectance in Design Example 10 of the present invention.

FIG. 37A is a graph (where the incident angle θ is 10°) showing a transmittance and a reflectance for TM polarized light and TE polarized light, and FIG. 37B is an enlarged graph showing a part of the reflectance in Design Example 10 of the present invention.

FIG. 38A is a graph (where the incident angle θ is 0°) showing a transmittance and a reflectance for TM polarized light and TE polarized light, and FIG. 38B is an enlarged graph showing a part of the reflectance in Design Example 11 of the present invention.

FIG. 39A is a graph (where the incident angle θ is 10°) showing a transmittance and a reflectance for TM polarized light and TE polarized light, and FIG. 39B is an enlarged graph showing a part of the reflectance in Design Example 11 of the present invention.

FIG. 40A is a graph (where the incident angle θ is 0°) showing a transmittance and a reflectance for TM polarized light and TE polarized light, and FIG. 40B is an enlarged graph showing a part of the reflectance in Design Example 12 of the present invention.

FIG. 41A is a graph (where the incident angle θ is 10°) showing a transmittance and a reflectance for TM polarized light and TE polarized light, and FIG. 41B is an enlarged graph showing a part of the reflectance in Design Example 12 of the present invention.

FIG. 42A is a graph (where the incident angle θ is 0°) showing a transmittance and a reflectance for TM polarized light and TE polarized light, and FIG. 42B is an enlarged graph showing a part of the reflectance in Design Example 13 of the present invention.

FIG. 43A is a graph (where the incident angle θ is 10°) showing a transmittance and a reflectance for TM polarized light and TE polarized light, and FIG. 43B is an enlarged graph showing a part of the reflectance in Design Example 13 of the present invention.

FIG. 44A is a graph (where the incident angle θ is 0°) showing a transmittance and a reflectance for TM polarized light and TE polarized light, and FIG. 44B is an enlarged graph showing a part of the reflectance in Design Example 14 of the present invention.

FIG. 45A is a graph (where the incident angle θ is 10°) showing a transmittance and a reflectance for TM polarized light and TE polarized light, and FIG. 45B is an enlarged graph showing a part of the reflectance in Design Example 14 of the present invention.

FIG. 46A is a graph (where the incident angle θ is 0°) showing a transmittance and a reflectance for TM polarized light and TE polarized light, and FIG. 46B is an enlarged graph showing a part of the reflectance in Design Example 15 of the present invention.

FIG. 47A is a graph (where the incident angle θ is 10°) showing a transmittance and a reflectance for TM polarized light and TE polarized light, and FIG. 47B is an enlarged graph showing a part of the reflectance in Design Example 15 of the present invention.

FIG. 48 is a graph showing a transmittance and a reflectance for TM polarized light and TE polarized light in Example 5 of the present invention.

FIG. 49 is a schematic view showing a laminated polarizer.

FIG. 50 is a schematic view showing an optical system of a liquid crystal projector.

### BEST MODE FOR CARRYING OUT THE INVENTION

Hereinafter, the present invention will be described more specifically by way of embodiments.

### Embodiment 1

To understand the principles of the present invention, first, the laminated polarizer will be described. FIG. 49 is a schematic view showing the laminated polarizer. As shown in FIG. 49, the laminated polarizer has a structure in which metal films 11 with a thickness of several nanometers and dielectric layers 12 with a thickness of several hundred nanometers are laminated alternately. When light enters the laminated polarizer in the in-plane direction of the metal film 11, a TE polarizing component of the incident light vibrates free electrons in the metal film 11 because the vibration direction of the electric field agrees with the in-plane direction of the metal film 11. Consequently, a current flows through the metal film 11, and the optical energy is absorbed as heat by the metal film 11. On the other hand, a TM polarizing component of the incident light is not likely to vibrate the free electrons in the metal film 11 because the vibration direction of the electric field agrees with the thickness direction of the metal film 11. Therefore, the optical energy is hardly absorbed by the metal film 11. Thus, this laminated polarizer can transmit only the TM polarizing component.

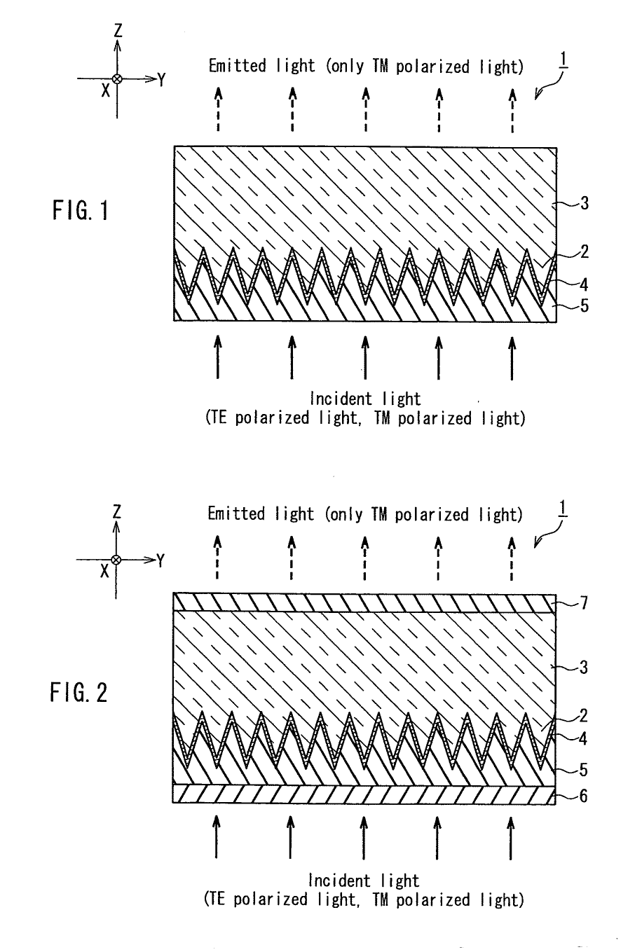

Next, a transmission type polarizing element of the present invention will be described. FIG. 1 is a cross-sectional view showing a transmission type polarizing element in Embodiment 1 of the present invention.

As shown in FIG. 1, a transmission type polarizing element 1 of this embodiment includes a dielectric substrate 3 having a structure in which a plurality of ridges 2 with an angle section are arranged parallel to each other on one side of the dielectric substrate 3, a thin film 4 that is made of a light absorbing substance and formed on the surfaces of the plurality of ridges 2 with an angle section, and a first dielectric substance layer 5 covering the surface of the thin film 4 that faces away from the dielectric substrate 3.

In this embodiment, the individual ridges 2 with an angle section are of the same shape with a triangular cross section and are arranged parallel to each other at a constant period. The thin film 4 made of a light absorbing substance is a metal film. The surface of the first dielectric substance layer 5 that faces away from the dielectric substrate 3 is a plane.

In the transmission type polarizing element 1 of this embodiment, the dimensions of the angle section and the structural period are made sufficiently smaller than the wavelength of light used so as to prevent the generation of harmful diffracted light.

Considering light that is incident perpendicularly on the transmission type polarizing element 1 from the first dielectric substance layer 5 side, a TE polarizing component of the incident light is likely to vibrate free electrons in the metal film, namely the thin film 4 made of a light absorbing substance, because the vibration direction of the electric field is parallel to the longitudinal direction of the ridges 2 (X-axis direction). Consequently, a current flows through the metal film, and the optical energy is absorbed as heat by the metal film. For a TM polarizing component of the incident light, the vibration direction of the electric field agrees with the Y-axis direction perpendicular to the longitudinal direction of the ridges 2 (i.e., the vibration direction of the magnetic field of the TM polarizing component is the same as the longitudinal direction of the ridges 2). In this case, since the vibration direction of the electric field is close to the thickness direction of the metal film, the free electrons in the metal film are not likely to vibrate, and the optical energy is hardly absorbed by the metal film. Thus, the transmission type polarizing element 1 of this embodiment can be used as a polarizing plate that transmits only the TM polarizing component.

In the case of the transmission type polarizing element 1 of this embodiment, the vibration direction of the electric field of the TM polarizing component is not completely perpendicular to the in-plane direction of the metal film. Therefore, the vibration of the free electrons in the metal film is more likely to occur, and the absorption of the optical energy relating to the TM polarizing component becomes larger compared to the laminated polarizer in FIG. 49. In the transmission type polarizing element 1 of this embodiment, there is no discontinuous portion in the metal film, so that a loss of the amount of light is increased.

On the other hand, the laminated polarizer in FIG. 49 has to be formed by superimposing a large number of very thin layers. This increases the cost and also makes it difficult to produce a laminated polarizer having a large area. In contrast, according to the configuration of the transmission type polarizing element 1 of this embodiment, a series of relatively simple steps of:

(1) processing grooves with a triangular cross section in the dielectric substrate 3 (i.e., forming the ridges 2 with a triangular cross section);

(2) forming the thin film 4 made of a light absorbing substance (metal film); and

(3) forming the first dielectric substance layer 5 can produce a transmission type polarizing element having a large area at low cost. Moreover, the configuration of the transmission type polarizing element 1 of this embodiment can control the loss of the amount of light of the TM polarizing component within a practical range, as will be described later in Design Examples.

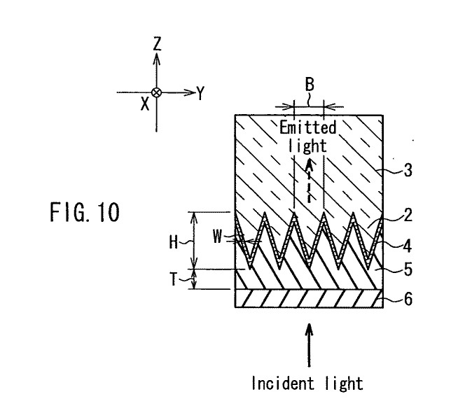

In the transmission type polarizing element 1 of this embodiment, the aspect ratio H/B of the height H to the base (period) B of an angle section of the dielectric substrate 3 (see FIG. 10) is preferably as large as possible. This is because if the material of the thin film 4 made of a light absorbing substance (metal film) is the same, the transmission type polarizing element 1 becomes closer to the configuration of the laminated polarizer in FIG. 49 as the aspect ratio increases, and thus the transmittance for the TM polarizing component and the extinction ratio can be larger.

The material of the dielectric substrate 3 of this embodiment may be a substance that is transparent to the wavelength region of light used, and preferably inorganic materials having good heat resistance such as fused quartz, optical glass, sheet glass, crystallized glass, and a semiconductor of single crystal silicon or the like. If the use of the transmission type polarizing element 1 does not require much heat resistance, plastic materials such as acryl and polycarbonate also can be used as the material of the dielectric substrate 3.

The plurality of ridges 2 with an angle section provided on the surface of the dielectric substrate 3 can be formed, e.g., in any of the following manners:

(a) a mask pattern of grooves arranged parallel to each other is formed on the surface of the dielectric substrate 3 and etched;

(b) a resin layer is applied to the surface of the dielectric substrate 3 and embossed (so-called nanoimprinting);

(c) a sol-gel glass layer is formed on the surface of the dielectric substrate 3, embossed, and then hardened; and

(d) the surface of the dielectric substrate 3 is directly embossed.

The material of the ridges 2 may differ from that of the remaining portion of the dielectric substrate 3.

As the material of the thin film 4 made of a light absorbing substance, titanium, tin, chromium, gold, silver, aluminum, copper, platinum, tungsten, molybdenum, nickel, niobium, etc. can be used as a simple substance or alloy. The material of the thin film 4 is not limited to metals, but may be a semiconductor of silicon or germanium, a compound semiconductor, or graphite. These materials are formed into a thin film by sputtering, vacuum deposition, chemical plating, liquid deposition, vapor phase epitaxy, or the like.

When the thin film 4 made of a light absorbing substance is directly in contact with the air, the reflectance at the interface is increased, resulting in a large proportion of return light. Moreover, when a metal is used as the material of the thin film 4 made of a light absorbing substance, dirt on the surface of the thin film 4 cannot be removed easily. For this reason, it is preferable that the surface of the thin film 4 that faces away from the dielectric substrate 3 is covered with the first dielectric substance layer 5, as described above, in order to avoid contact with the air. The first dielectric substance layer 5 is not essential to the present invention, and can be omitted if the transmission type polarizing element is used in applications where the problems of return light and dirt can be ignored.

The surface of the thin film 4 that faces away from the dielectric substrate 3 may be covered with the first dielectric substance layer 5, e.g., in any of the following manners:

(e) a glass layer composed mainly of quartz is deposited by CVD (chemical vapor deposition);

(f) sol-gel glass is applied and hardened;

(g) a curable resin material is applied and cured by ultraviolet irradiation or heating; and

(h) a glass material is deposited by sputtering.

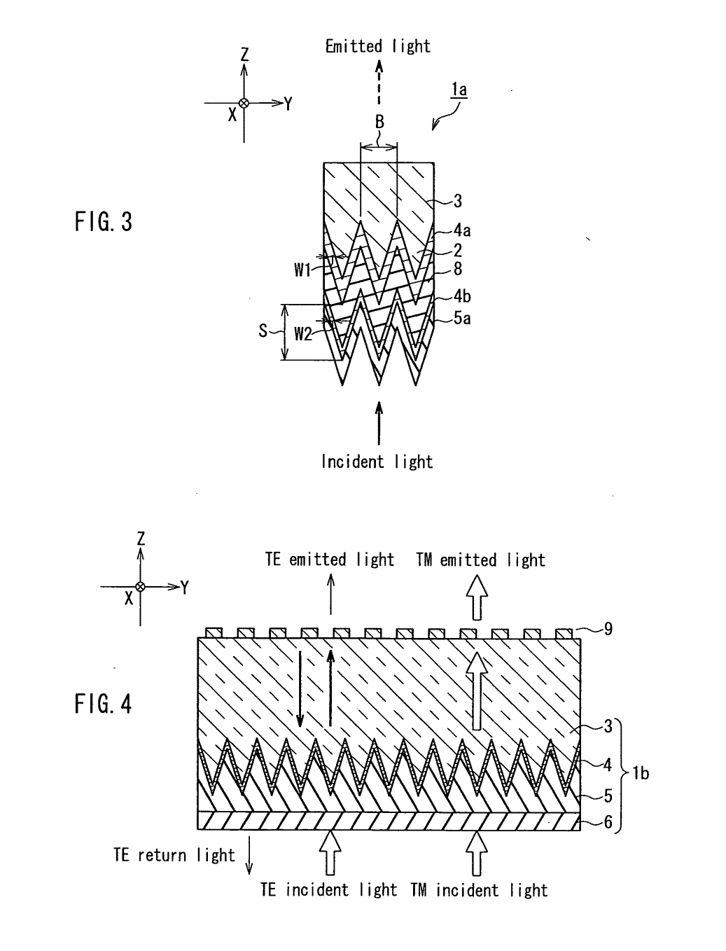

In this embodiment, the surface of the first dielectric substance layer 5 that faces away from the dielectric substrate 3 is described as being a plane, but the present invention is not necessarily limited to this configuration. The surface of the first dielectric substance layer 5 that faces away from the dielectric substrate 3 may have a shape that follows the angle section (see “5a” in FIG. 3).

### Embodiment 2

FIG. 2 is a cross-sectional view showing a transmission type polarizing element in Embodiment 2 of the present invention.

As shown in FIG. 2, a single- or multi-layer first antireflection layer 6 is provided on the surface of the first dielectric substance layer 5 that faces away from the dielectric substrate 3. Moreover, a single- or multi-layer second antireflection layer 7 is provided on the surface of the dielectric substrate 3 that faces away from the first dielectric substance layer 5. The other configurations are similar to those of the transmission type polarizing element 1 in Embodiment 1, and therefore the same members as those shown in FIG. 1 are denoted by the same reference numerals and their explanations will not be repeated.

The materials of the first and second antireflection layers 6, 7 may be Ta₂O₅ (refractive index: 2.1), TiO₂ (refractive index: 2.2 to 2.5), Nb₂O₅ (refractive index: 2.35), MgF₂ (refractive index: 1.38), SiO₂ (refractive index: 1.45), Y₂O₃ (refractive index 1.8), MgO (refractive index: 1.7), Al₂O₃ (refractive index: 1.63), etc. These materials can be formed into a film by vacuum deposition, sputtering, chemical vapor deposition, or the like.

With the configuration of this embodiment, the first and second antireflection layers 6, 7 are provided so as to sandwich the transmission type polarizing element 1 in Embodiment 1, thereby achieving a further reduction in return light. The first and second antireflection layers 6, 7 are not essential to the present invention, and can be omitted if the transmission type polarizing element is used in applications where the problem of return light can be ignored.

### Embodiment 3

FIG. 3 is a cross-sectional view showing a transmission type polarizing element in Embodiment 3 of the present invention.

In the transmission type polarizing element of this embodiment, a plurality of thin films made of a light absorbing substance are disposed with a second dielectric substance layer interposed between them. Hereinafter, the transmission type polarizing element of this embodiment will be described in more detail with reference to FIG. 3.

As shown in FIG. 3, in a transmission type polarizing element 1a of this embodiment, first and second metal films 4a, 4b serving as the thin films made of a light absorbing substance are disposed in this order from the dielectric substrate 3 side with a second dielectric substance layer 8 interposed between them. The surface of the second metal film 4b that faces away from the dielectric substrate 3 is covered with a first dielectric substance layer 5a. The extinction ratio of the whole element is approximately a product of the extinction ratios of the metal films 4a, 4b. Therefore, the configuration of this embodiment can provide a large extinction ratio.

The transmission type polarizing element 1a of this embodiment can be produced by depositing a metal and a dielectric substance alternately on the dielectric substrate 3 having a structure in which a plurality of ridges 2 with an angle section are arranged parallel to each other on one side of the dielectric substrate 3. In FIG. 3, the first dielectric substance layer 5a covers the second metal film 4b, and the surface of the first dielectric substance layer 5a that faces away from the dielectric substrate 3 has a shape that follows the angle section.

In FIG. 3, both the first metal film 4a (with a thickness of W1 in the Y-axis direction) and the second metal film 4b (with a thickness of W2 in the Y-axis direction) reflect incident light, and the reflectances increase with increasing the thicknesses of the first and second metal films 4a, 4b. However, when the reflectance of each of the metal films 4a, 4b and a space S between the metal films 4a, 4b in the Z-axis direction (i.e., the incident direction of light) are adjusted, the amplitudes of the reflected rays from the metal films 4a, 4b can be about the same, and the phases of the reflected rays can be shifted by a half period. Thus, the reflected rays cancel each other out by interference, so that the reflectance of the whole element can be reduced.

As described in this embodiment, the arrangement of a plurality of thin films made of a light absorbing substance (metal films) can increase the extinction ratio and control the reflected rays, thus increasing the degree of freedom in design.

In this embodiment, the metal films 4a, 4b are used as the thin films made of a light absorbing substance. However, in addition to the metal, the examples of the materials described in Embodiment 1 also can be used as a material of the thin film made of a light absorbing substance.

### Embodiment 4

FIG. 4 is a cross-sectional view showing a composite polarizing plate in Embodiment 4 of the present invention.

When the transmission type polarizing element of the present invention lacks the extinction ratio, a plurality of the transmission type polarizing elements may be used by being superimposed on one another. However, the lack of the extinction ratio also can be compensated by using a combination of the transmission type polarizing element of the present invention and another transmission type polarizing element that is not derived from the present invention (i.e., a composite polarizing plate). Hereinafter, a composite polarizing plate of this embodiment will be described in more detail with reference to FIG. 4.

As shown in FIG. 4, the composite polarizing plate of this embodiment includes a first transmission type polarizing element 1b disposed on the light incident side and a second transmission type polarizing element 9 disposed on the light emitting side. Only the first transmission type polarizing element 1b of the first and second transmission type polarizing elements 1b, 9 is derived from the present invention. In other words, the first transmission type polarizing element 1b is configured so that the single- or multi-layer first antireflection layer 6 is provided on the surface of the first dielectric substance layer 5 that faces away from the dielectric substrate 3 of the transmission type polarizing element 1 in Embodiment 1 (see FIG. 1).

As the second transmission type polarizing element 9, e.g., a general wire-grid polarizing plate can be used.

In the composite polarizing plate of this embodiment, the first transmission type polarizing element 1b of the present invention that is disposed on the light incident side transmits a TM polarizing component and absorbs a TE polarizing component. On the other hand, the second transmission type polarizing element 9 that is not derived from the present invention and is disposed on the light emitting side transmits the TM polarizing component and reflects the TE polarizing component.

The first transmission type polarizing element 1b of the composite polarizing plate in FIG. 4 has a small extinction ratio. In this embodiment, the extinction ratio of the first transmission type polarizing element 1b is set to 20. However, when the second transmission type polarizing element 9 (e.g., having an extinction ratio of 30) is superimposed on the first transmission type polarizing element 1b, the extinction ratio of the whole element can be a large value given by 20×30=600. The transmittance of the second transmission type polarizing element 9 such as a wire-grid polarizing plate for the TM polarizing component is high and can be 90% or more if the extinction ratio is small. Therefore, the transmittance of the whole composite polarizing plate for the TM polarizing component can be maintained at a high level. Most of the TE polarizing component that has passed through the first transmission type polarizing element 1b is reflected from the second transmission type polarizing element 9 and absorbed again by the first transmission type polarizing element 1b. Thus, there is almost no return light.

As will be described later in Design Examples, in the transmission type polarizing element of the present invention, “increasing the aspect ratio” and “increasing the number of thin films made of a light absorbing substance (e.g., metal films)” can be effective means to satisfy simultaneously the following preferred properties:

(i) a high transmittance for the TM polarizing component;

(j) a low transmittance for the TE polarizing component (i.e., a large extinction ratio); and

(k) a low reflectance.

However, it becomes more difficult to produce such a transmission type polarizing element. In contrast, the transmission type polarizing element of the present invention that simultaneously satisfies the following properties:

(l) a high transmittance for the TM polarizing component;

(m) a rather high transmittance for the TE polarizing component (i.e., a small extinction ratio); and

(n) a low reflectance

can be produced relatively easily under the conditions that “the aspect ratio is small” or “the number of thin films made of a light absorbing substance (e.g., metal films) is small”. Thus, the composite polarizing plate in FIG. 4 is very practical in view of the degree of difficulty in production, although it includes two transmission type polarizing elements 1b, 9.

In the composite polarizing plate in FIG. 4, an inexpensive absorption type directional organic film may be used as the second transmission type polarizing element 9, but is likely to be degraded by absorbing the energy of the TE polarizing component. However, since most of the TE polarizing component is removed by the first transmission type polarizing element 1b, the degradation of the organic film may not be a problem for the composite polarizing plate in FIG. 4.

In the composite polarizing plate in FIG. 4, an absorption type polarizing element other than the transmission type polarizing element of the present invention may be used as the first transmission type polarizing element 1b. For example, the first transmission type polarizing element 1b can be the above-described “laminated polarizer”, “glass layer randomly including small acicular metals that are aligned in the same direction”, or “dielectric photonic crystal in which metal strips are arranged in many layers”.

In the composite polarizing plate in FIG. 4, the first transmission type polarizing element 1b and the second transmission type polarizing element 9 are disposed on both sides of the same dielectric substrate 3. However, the first and second polarizing elements 1b, 9 may be disposed on separate substrates, and these substrates may be combined together.

### Embodiment 5

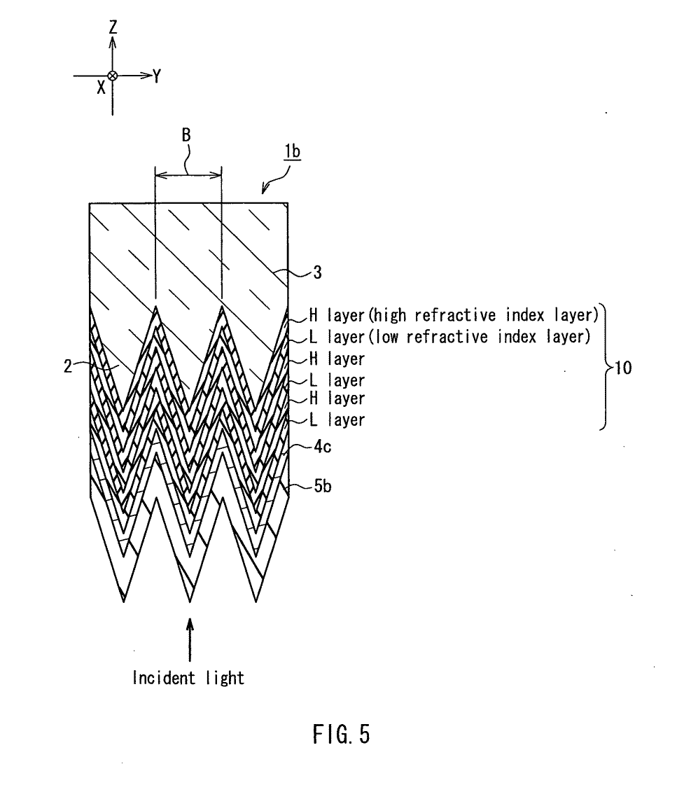

FIG. 5 is a cross-sectional view showing a transmission type polarizing element in Embodiment 5 of the present invention.

In the transmission type polarizing element of this embodiment, a dielectric multi-layer film having a shape that follows the angle section of the ridges is disposed between the thin film made of a light absorbing substance and the dielectric substrate. Hereinafter, the transmission type polarizing element of this embodiment will be described in more detail with reference to FIG. 5.

As shown in FIG. 5, in a transmission type polarizing element 1b of this embodiment, a dielectric multi-layer film 10 having a shape that follows the angle section of the ridges 2 is disposed between a metal film 4c serving as the thin film made of a light absorbing substance and the dielectric substrate 3. The surface of the metal film 4c that faces away from the dielectric multi-layer film 10 is covered with a first dielectric substance layer 5b for the purposes of antireflection and surface protection of the metal film 4c.

The transmission type polarizing element 1b of this embodiment can be produced in such a manner that the dielectric multi-layer film 10 is formed by laminating high refractive index layers (H layers) and low refractive index layers (L layers) alternately on the dielectric substrate 3 having a structure in which a plurality of ridges 2 with an angle section are arranged parallel to each other on one side of the dielectric substrate 3, and then the metal film 4c and the first dielectric substance layer 5b are formed in this order on the dielectric multi-layer film 10. The dielectric multi-layer film 10 can be formed, e.g., by an “autocloning” technology that is known as a method for producing a photonic crystal (see, e.g., Japanese Patent No. 3486334).

As described above, in the transmission type polarizing element 1b of this embodiment, the dielectric multi-layer film 10 has a shape that follows the angle section of the ridges 2. In this case, since the plurality of ridges 2 with an angle section are arranged periodically in the Y-axis direction (i.e., the angle structure is present only in the Y-axis direction), the dielectric multi-layer film 10 has the polarization properties. Therefore, the dielectric multi-layer film 10 can transmit approximately 100% of the TM polarized light, while it can reflect a part of the TE polarized light and transmit the remainder. When the dielectric multi-layer film 10 is allowed to have these properties, the TM polarizing component of the incident light is absorbed to some extent by the metal film 4c and subsequently passes through the dielectric multi-layer film 10, while the TE polarizing component of the incident light is absorbed significantly by the metal film 4c, reflected from the dielectric multi-layer film 10, and then absorbed by the metal film 4c again. Only the TE polarizing component is absorbed twice, so that the extinction ratio can be increased further. The structure in FIG. 5 can be considered as an integrated structure of the “double transmission type polarizing elements” in Embodiment 4.

### Embodiment 6

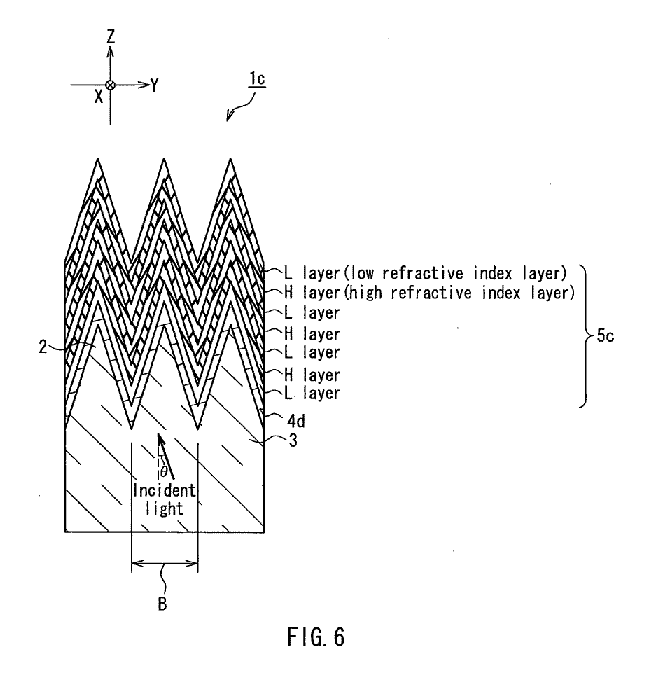

FIG. 6 is a cross-sectional view showing a transmission type polarizing element in Embodiment 6 of the present invention.

In the transmission type polarizing element of this embodiment, the first dielectric substance layer covering the surface of the thin film that faces away from the dielectric substrate is a dielectric multi-layer film having a shape that follows the angle section of the ridges. Hereinafter, the transmission type polarizing element of this embodiment will be described in more detail with reference to FIG. 6.

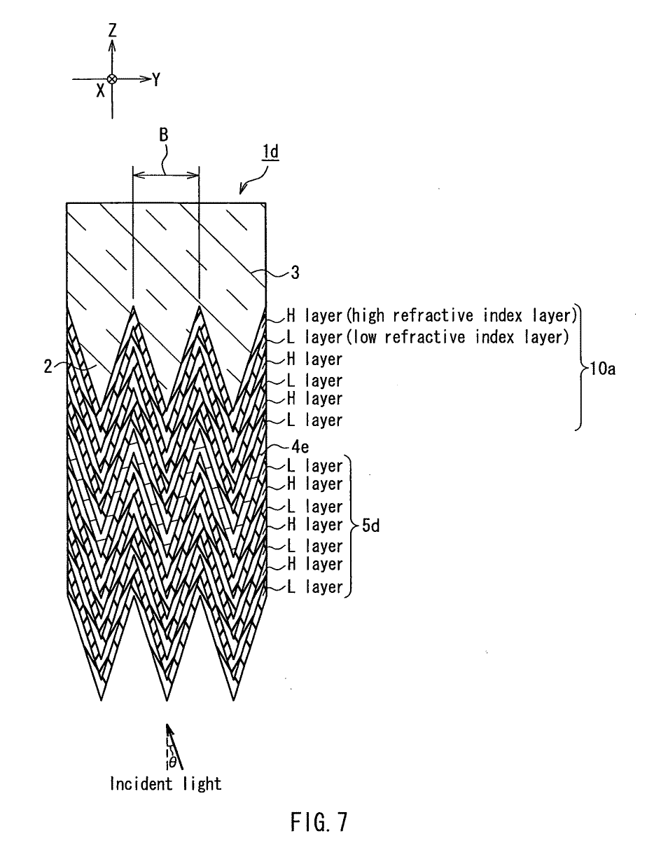

As shown in FIG. 6, in a transmission type polarizing element 1c of this embodiment, the first dielectric substance layer covering the surface of a metal film 4d (serving as the thin film made of a light absorbing substance) that faces away from the dielectric substrate 3 is a dielectric multi-layer film 5c having a shape that follows the angle section of the ridges 2. In FIG. 6, θ represents the incident angle of incident light (this is also the same in FIG. 7).

The transmission type polarizing element 1c of this embodiment can be produced in such a manner that the metal film 4d is formed on the dielectric substrate 3 having a structure in which a plurality of ridges 2 with an angle section are arranged parallel to each other on one side of the dielectric substrate 3, and then the dielectric multi-layer film 5c is formed by laminating low refractive index layers (L layers) and high refractive index layers (H layers) alternately on the metal film 4d. Like the dielectric multi-layer film 10 in Embodiment 5, the dielectric multi-layer film 5c also can be formed, e.g., by an “autocloning” technology that is known as a method for producing a photonic crystal.

The structure in FIG. 6 is provided so that the direction of incident light is opposite to that of the transmission type polarizing element 1b (FIG. 5) in Embodiment 5, and the metal film 4d is provided on the dielectric substrate 3 side.

### Embodiment 7

FIG. 7 is a cross-sectional view showing a transmission type polarizing element in Embodiment 7 of the present invention.

In the transmission type polarizing element of this embodiment, the configuration of Embodiment 5 is combined with the configuration of Embodiment 6, and the dielectric multi-layer films are provided on both sides of the metal film. Hereinafter, the transmission type polarizing element of this embodiment will be described in more detail with reference to FIG. 7.

As shown in FIG. 7, in a transmission type polarizing element 1d of this embodiment, a dielectric multi-layer film 10a having a shape that follows the angle section of the ridges 2 is provided between a metal film 4e serving as the thin film made of a light absorbing substance and the dielectric substrate 3. Moreover, the first dielectric substance layer covering the surface of the metal film 4e that faces away from the dielectric substrate 3 (or the dielectric multi-layer film 10a) is a dielectric multi-layer film 5d having a shape that follows the angle section of the ridges 2.

The transmission type polarizing element 1d of this embodiment can be produced in such a manner that the dielectric multi-layer film 10a is formed by laminating high refractive index layers (H layers) and low refractive index layers (L layers) alternately on the dielectric substrate 3 having a structure in which a plurality of ridges 2 with an angle section are arranged parallel to each other on one side of the dielectric substrate 3, the metal film 4e is formed on the dielectric multi-layer film 10a, and then the dielectric multi-layer film 5d is formed by laminating low refractive index layers (L layers) and high refractive index layers (H layers) alternately on the metal film 4e.

In the configuration of this embodiment, the TE polarizing component is reflected repeatedly from the two dielectric multi-layer films 10a, 5d that sandwich the metal film 4e. Therefore, the amount of absorption of the metal film 4e can be increased further, thus increasing the extinction ratio.

In Embodiments 1 to 3 and 5 to 7, it is also possible to replace the light incident side with the light emitting side.

In Embodiments 5 to 7, although the metal film is described as being a single layer, a plurality of metal films also can be used for antireflection or the like, similarly to Embodiment 3.

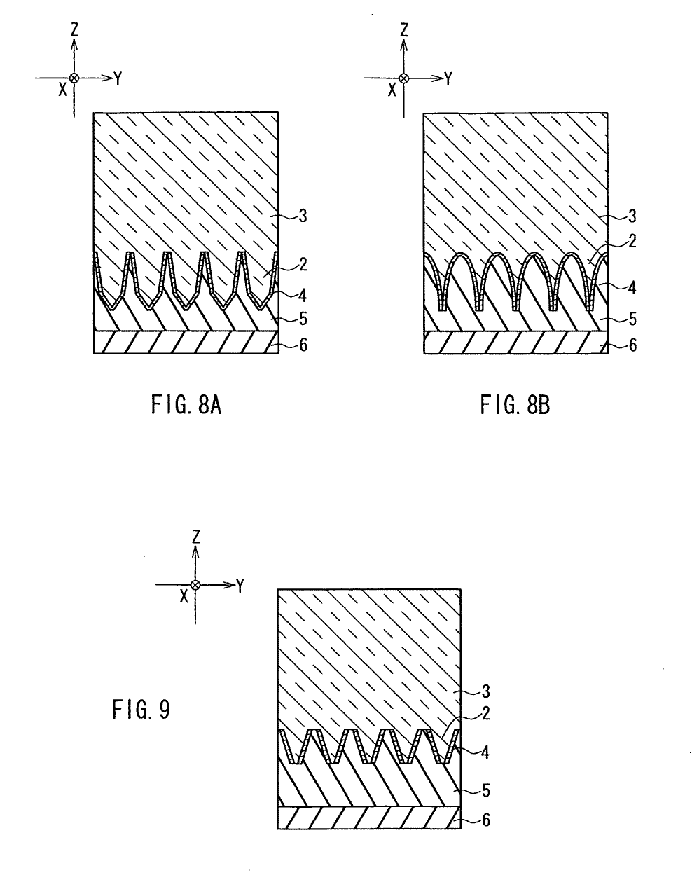

In each of Embodiments, the ridges 2 with an angle section are described as having a triangular cross section, but are not limited thereto. For example, the ridges 2 may have shapes as shown in FIGS. 8A and 8B as long as the depth in the Z-axis direction is ensured.

In each of Embodiments, the thin film made of a light absorbing substance (e.g., a metal film) is formed on the entire surface of the ridges 2 with an angle section (or the dielectric multi-layer films 10, 10a). As shown in FIG. 9, however, the thin film 4 made of a light absorbing substance may be discontinuous at the top of the angle section. This configuration can provide the effect of increasing the transmittance for the TM polarizing component.

Moreover, even if the plurality of ridges 2 with an angle section vary somewhat in base B, height H, and shape, the optical characteristics of the transmission type polarizing element of the present invention can be exhibited sufficiently.

### DESIGN EXAMPLES

Design examples of the above transmission type polarizing elements will be described below.

In FIG. 10, a plane wave (TE polarized light and TM polarized light) was incident perpendicularly from the air side (i.e., the first antireflection layer 6 side) on the transmission type polarizing element, and a transmittance, a reflectance, and an absorptance were calculated. For the TE polarized light, the vibration direction of the electric field was the X-axis direction (i.e., the longitudinal direction of the ridges). For the TM polarized light, the vibration direction of the magnetic field was the X-axis direction. The plurality of ridges with an angle section of the transmission type polarizing element were arranged periodically in the Y-axis direction, and the structural period was equal to the length B of the base of the angle section. The transmittance, the reflectance, and the absorptance were calculated using calculation software “DiffractMOD” (manufactured by RSoft Design Group, Inc. in the United States of America) based on the RCWA (rigorous coupled wave analysis) method.

### Design Example 1

In Design Example 1, the transmission type polarizing element shown in FIG. 10 was defined as follows.

(A) Refractive index of the dielectric substrate 3: 1.45

(B) Base of the angle section of the dielectric substrate 3: B=180 nm (equal to the structural period in the Y-axis direction)

(C) Height of the angle section of the dielectric substrate 3: H=360 nm (the aspect ratio was 2.0)

(D) Refractive index of the ridges with an angle section of the dielectric substrate 3: 1.45

(E) Thickness of the thin film 4 made of a light absorbing substance in the Y-axis direction: W=10 nm

(F) Complex refractive index of the thin film 4 made of a light absorbing substance: n=2.91+4.07i (which is a constant value regardless of the frequency of light)

(G) Refractive index of the first dielectric substance layer 5: 1.45

(H) Thickness of the first dielectric substance layer 5 in the Z-axis direction, measured from the top of the angle section: T=28 nm

(I) Structure of the first antireflection layer 6

(Substrate Side)

First layer: a refractive index of 1.62; a physical thickness of 60 nm

Second layer: a refractive index of 2.10; a physical thickness of 69 nm

Third layer: a refractive index of 1.38; a physical thickness of 77 nm

(Air Side)

The thickness W of the thin film 4 made of a light absorbing substance in the Y-axis direction was set so that the transmittance for the TE polarizing component was about 0.2% or less in the wavelength region of light used. The complex refractive index n of the thin film 4 made of a light absorbing substance was close to the value of Cr (chromium) at a wavelength of 0.47 μm.

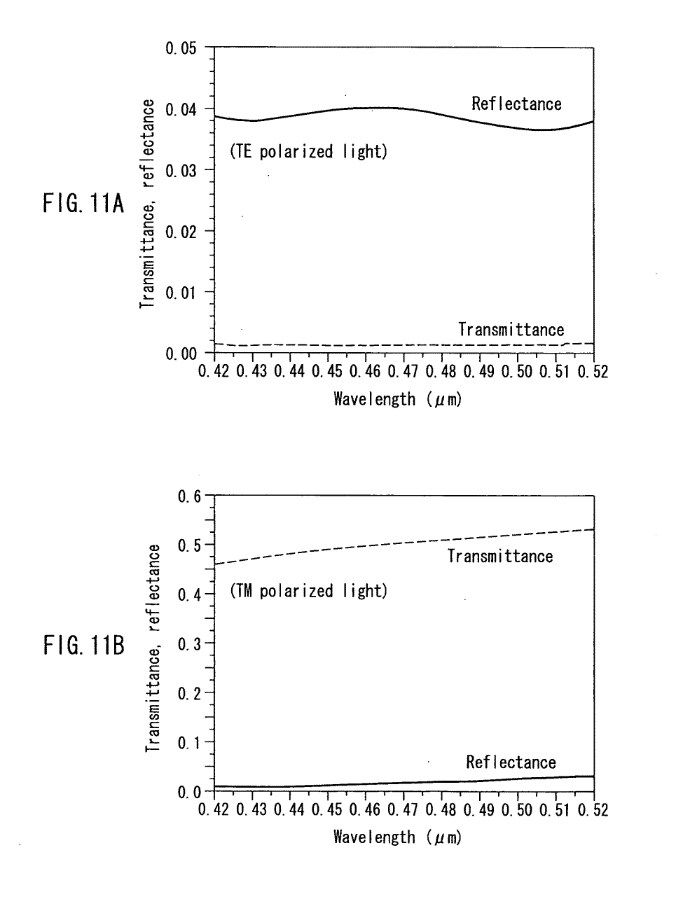

FIGS. 11A and 11B show a reflectance on the air side and a transmittance on the dielectric substrate 3 side for the TE polarized light and the TM polarized light, respectively, when light having a wavelength of 0.42 μm to 0.52 μm in a vacuum was incident perpendicularly from the air side on the transmission type polarizing element of Design Example 1. Similarly, the following design examples and reference examples show a reflectance and a transmittance for the TE polarized light and the TM polarized light, respectively, using light having the same wavelength.

The incident energy except for reflection and transmission was absorbed by the thin film 4 made of a light absorbing substance. In this case, the transmittance was calculated from the energy of light before the light exited from the dielectric substrate 3 to the outside. The reason for this is to eliminate the effect of Fresnel reflection that occurs at the time of emission of light to the outside (e.g., the air side).

As shown in FIG. 11A, in the case of the TE polarized light, both the reflectance and the transmittance are extremely small, and most of the incident energy is absorbed by the thin film 4 made of a light absorbing substance. On the other hand, as shown in FIG. 11B, in the case of the TM polarized light, the transmittance is as large as 46 to 53%. Thus, it is clear that the transmission type polarizing element of Design Example 1 acts as a polarizing plate.

For example, at a wavelength of 0.47 μm,

TE polarized light: a reflectance of 4.0%; a transmittance of 0.2% (the remainder was absorbed) and

TM polarized light: a reflectance of 1.5%; a transmittance of 50% (the remainder was absorbed). Accordingly, the polarization extinction ratio of the transmitted light is 250.

### Design Example 2

In Design Example 2, the aspect ratio was larger than that of Design Example 1. The thickness W of the thin film 4 made of a light absorbing substance in the Y-axis direction was set so that the transmittance for the TE polarizing component was about 0.2% or less in the wavelength region of light used. The items other than the following are the same as those of Design Example 1.

(C) Height of the angle section of the dielectric substrate 3: H=720 nm (the aspect ratio was 4.0)

(E) Thickness of the thin film 4 made of a light absorbing substance in the Y-axis direction: W=4.5 nm

(H) Thickness of the first dielectric substance layer 5 in the Z-axis direction, measured from the top of the angle section: T=6 nm

(I) Structure of the first antireflection layer 6

(Substrate Side)

First layer: a refractive index of 1.62; a physical thickness of 69 nm

Second layer: a refractive index of 2.10; a physical thickness of 79 nm

Third layer: a refractive index of 1.38; a physical thickness of 75 nm

(Air Side)

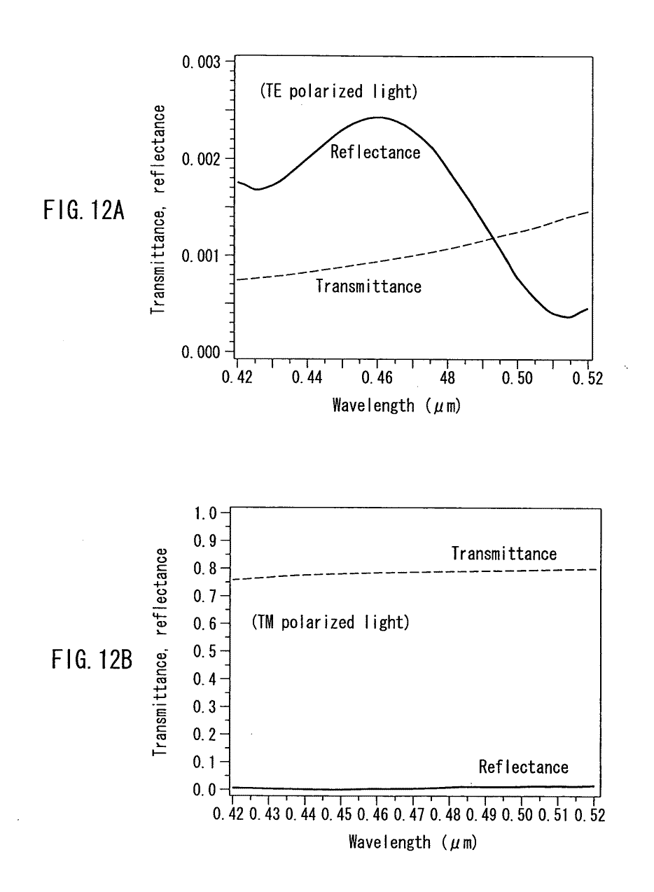

FIGS. 12A and 12B show a reflectance and a transmittance of the transmission type polarizing element of Design Example 2 for the TE polarized light and the TM polarized light, respectively.

For example, at a wavelength of 0.47 μm,

TE polarized light: a reflectance of 0.23%; a transmittance of 0.10% (the remainder was absorbed) and

TM polarized light: a reflectance of 0.6%; a transmittance of 79% (the remainder was absorbed). Accordingly, the polarization extinction ratio of the transmitted light is 790.

Since the aspect ratio is larger in Design Example 2 than in Design Example 1, the properties of the transmission type polarizing element are improved.

### Design Example 3

In Design Example 3, the thin film 4 made of a light absorbing substance in Design Example 1 was replaced by a material that absorbs less light (having a small extinction coefficient, which is an imaginary component of the refractive index). Specifically, the complex refractive index of the thin film 4 made of a light absorbing substance in Design Example 3 was close to the value of Sn (tin) at a wavelength of 0.47 μm. The thickness W of the thin film 4 made of a light absorbing substance in the Y-axis direction was set so that the transmittance for the TE polarizing component was about 0.2% or less in the wavelength region of light used. The items other than the following are the same as those of Design Example 1.

(E) Thickness of the thin film 4 made of a light absorbing substance in the Y-axis direction: W=12 nm

(F) Complex refractive index of the thin film 4 made of a light absorbing substance: n=2.83+2.80i (which is a constant value regardless of the frequency of light)

(H) Thickness of the first dielectric substance layer 5 in the Z-axis direction, measured from the top of the angle section: T=18 nm

(I) Structure of the first antireflection layer 6

(Substrate Side)

First layer: a refractive index of 1.62; a physical thickness of 69 nm

Second layer: a refractive index of 2.10; a physical thickness of 79 nm

Third layer: a refractive index of 1.38; a physical thickness of 82 nm

(Air Side)

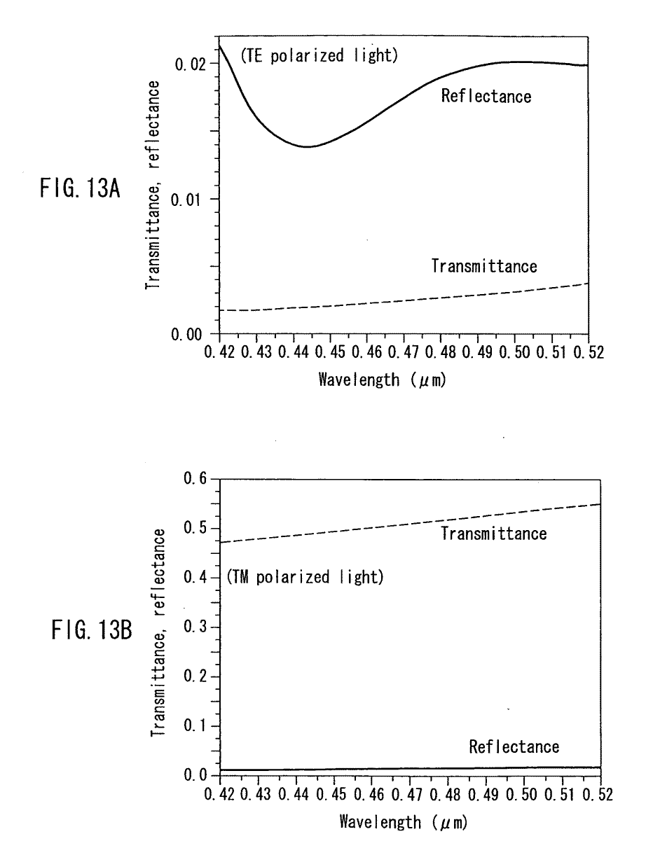

FIGS. 13A and 13B show a reflectance and a transmittance of the transmission type polarizing element of Design Example 3 for the TE polarized light and the TM polarized light, respectively.

For example, at a wavelength of 0.47 μm,

TE polarized light: a reflectance of 1.75%; a transmittance of 0.24% (the remainder was absorbed) and

TM polarized light: a reflectance of 1.2%; a transmittance of 51% (the remainder was absorbed). Accordingly, the polarization extinction ratio of the transmitted light is 213.

### Design Example 4

In Design Example 4, the thickness W of the thin film 4 made of a light absorbing substance in the Y-axis direction of Design Example 1 was reduced so that the transmittance for the TE polarizing component was about 4% or less in the wavelength region of light used. The items other than the following are the same as those of Design Example 1.

(E) Thickness of the thin film 4 made of a light absorbing substance in the Y-axis direction: W=4.4 nm

(H) Thickness of the first dielectric substance layer 5 in the Z-axis direction, measured from the top of the angle section: T=47 nm

(I) Structure of the first antireflection layer 6

(Substrate Side)

First layer: a refractive index of 1.62; a physical thickness of 75 nm

Second layer: a refractive index of 2.10; a physical thickness of 125 nm

Third layer: a refractive index of 1.38; a physical thickness of 83 nm

(Air Side)

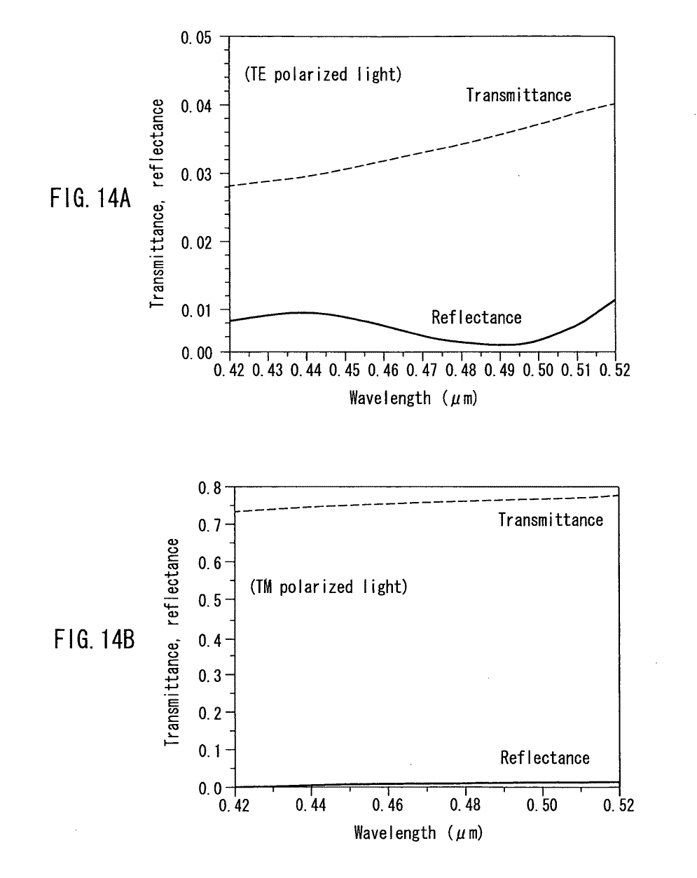

FIGS. 14A and 14B show a reflectance and a transmittance of the transmission type polarizing element of Design Example 4 for the TE polarized light and the TM polarized light, respectively.

For example, at a wavelength of 0.47 μm,

TE polarized light: a reflectance of 0.6%; a transmittance of 3.3% (the remainder was absorbed) and

TM polarized light: a reflectance of 0.45%; a transmittance of 76% (the remainder was absorbed). Accordingly, the polarization extinction ratio of the transmitted light is 23.

In Design Example 4, the thickness W of the thin film 4 made of a light absorbing substance in the Y-axis direction of Design Example 1 was reduced, thereby increasing the transmittance for the TM polarizing component. As a result, the transmittance for the TE polarizing component also was increased, and the extinction ratio became smaller. However, the lack of the extinction ratio can be compensated by using the configuration as shown in FIG. 4.

### Design Example 5

In Design Example 5, the first dielectric substance layer 5 and the first antireflection layer 6 of Design Example 1 were removed, and the surface of the thin film 4 made of a light absorbing substance was brought into direct contact with the air. The thickness W of the thin film 4 made of a light absorbing substance in the Y-axis direction was set so that the transmittance for the TE polarizing component was about 0.2% or less in the wavelength region of light used. The items other than the following are the same as those of Design Example 1.

(E) Thickness of the thin film 4 made of a light absorbing substance in the Y-axis direction: W=7.7 nm

The first dielectric substance layer 5: removed

The first antireflection layer 6: removed

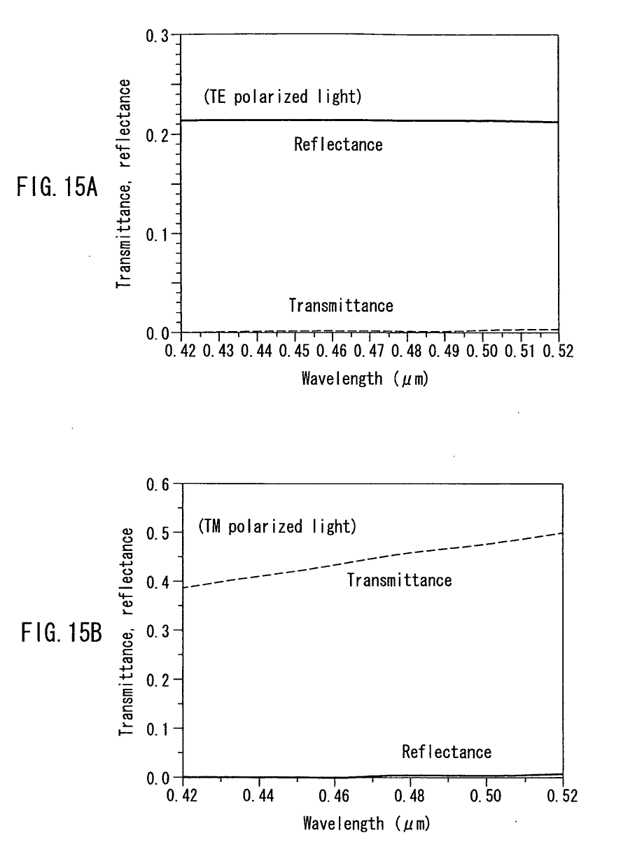

FIGS. 15A and 15B show a reflectance and a transmittance of the transmission type polarizing element of Design Example 5 for the TE polarized light and the TM polarized light, respectively.

For example, at a wavelength of 0.47 μm,

TE polarized light: a reflectance of 21%; a transmittance of 0.14% (the remainder was absorbed) and

TM polarized light: a reflectance of 0.12%; a transmittance of 45% (the remainder was absorbed). Accordingly, the polarization extinction ratio of the transmitted light is 329.

In Design Example 5, since the surface of the thin film 4 made of a light absorbing substance was in direct contact with the air, the reflectance for the TE polarizing component was increased. Therefore, the transmission type polarizing element of Design Example 5 can be used in applications where a large amount of reflected light is not a problem.

### Reference Example 1

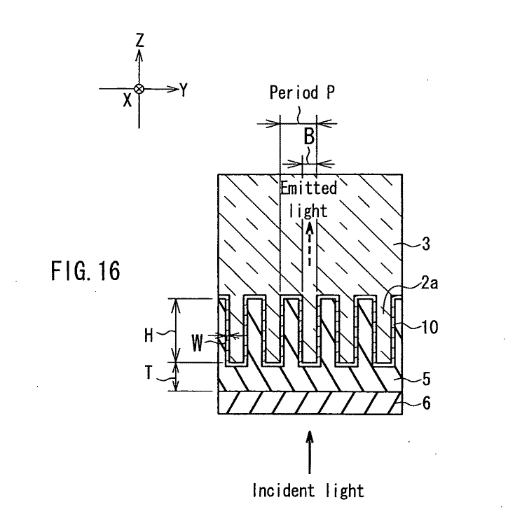

In FIG. 16, a plane wave (TE polarized light and TM polarized light) was incident perpendicularly from the air side (i.e., the first antireflection layer 6 side) on the transmission type polarizing element having ridges 2a with a rectangular cross section, and a transmittance, a reflectance, and an absorptance were calculated. The plurality of ridges with a rectangular cross section were arranged periodically in the Y-axis direction, and the structural period was represented by P. The base and height of the rectangular cross section were represented by B and H, respectively.

The transmission type polarizing element shown in FIG. 16 was defined as follows.

(A) Refractive index of the dielectric substrate 3: 1.45

(B) Base of the rectangular cross section of the dielectric substrate 3: B=90 nm

(B1) Structural period of the plurality of ridges with a rectangular cross section of the dielectric substrate 3 in the Y-axis direction: P=180 nm

(C) Height of the rectangular cross section of the dielectric substrate 3: H=360 nm (the aspect ratio was 4.0)

(D) Refractive index of the ridges with a rectangular cross section of the dielectric substrate 3: 1.45

(E) Thickness of a thin film 10 made of a light absorbing substance: W=6.5 nm

(F) Complex refractive index of the thin film 10 made of a light absorbing substance: n=2.91+4.07i (which is a constant value regardless of the frequency of light)

(G) Refractive index of the first dielectric substance layer 5: 1.45

(H) Thickness of the first dielectric substance layer 5 in the Z-axis direction, measured from the end of the rectangular cross section: T=6 nm

(I) Structure of the first antireflection layer 6

(Substrate Side)

First layer: a refractive index of 1.62; a physical thickness of 117 nm

Second layer: a refractive index of 2.10; a physical thickness of 57 nm

Third layer: a refractive index of 1.38; a physical thickness of 79 nm

(Air Side)

The thickness W of the thin film 10 made of a light absorbing substance was set so that the transmittance for the TE polarizing component was about 0.2% or less in the wavelength region of light used.

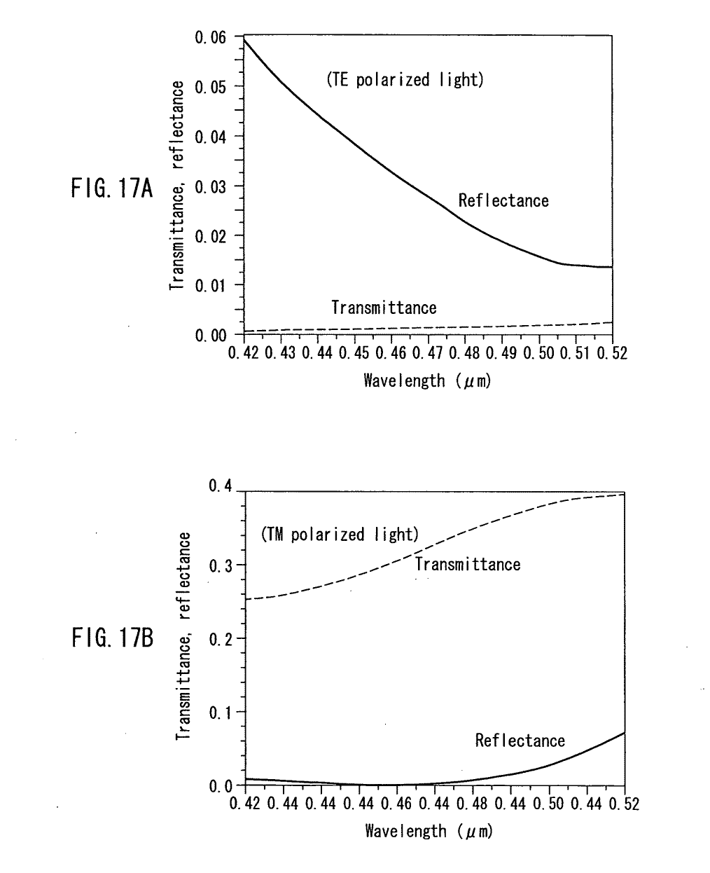

FIGS. 17A and 17B show a reflectance and a transmittance of the transmission type polarizing element of Reference Example 1 for the TE polarized light and the TM polarized light, respectively. The incident energy except for reflection and transmission was absorbed by the thin film 10 made of a light absorbing substance.

For example, at a wavelength of 0.47 μm,

TE polarized light: a reflectance of 2.8%; a transmittance of 0.13% (the remainder was absorbed) and

TM polarized light: a reflectance of 0.12%; a transmittance of 33% (the remainder was absorbed). Accordingly, the polarization extinction ratio of the transmitted light is 254.

Comparing the transmission type polarizing element of Reference Example 1 and that of Design Example 1 in which the height H is the same, the transmittance for the TM polarizing component of Reference Example 1 is reduced significantly. Therefore, the transmission type polarizing element having the ridges 2a with a rectangular cross section of Reference Example 1 is not suitable for the use of a polarizing plate.

### Reference Example 2

In Reference Example 2, the aspect ratio was smaller than that of Reference Example 1. The thickness W of the thin film 10 made of a light absorbing substance was set so that the transmittance for the TE polarizing component was about 0.2% or less in the wavelength region of light used. The items other than the following are the same as those of Reference Example 1.

(C) Height of the rectangular cross section of the dielectric substrate 3: H=90 nm (the aspect ratio was 1.0)

(E) Thickness of the thin film 10 made of a light absorbing substance: W=28 nm

(H) Thickness of the first dielectric substance layer 5 in the Z-axis direction, measured from the end of the rectangular cross section: T=14 nm

(I) Structure of the first antireflection layer 6

(Substrate Side)

First layer: a refractive index of 1.62; a physical thickness of 127 nm

Second layer: a refractive index of 2.10; a physical thickness of 37 nm

Third layer: a refractive index of 1.38; a physical thickness of 42 nm

(Air Side)

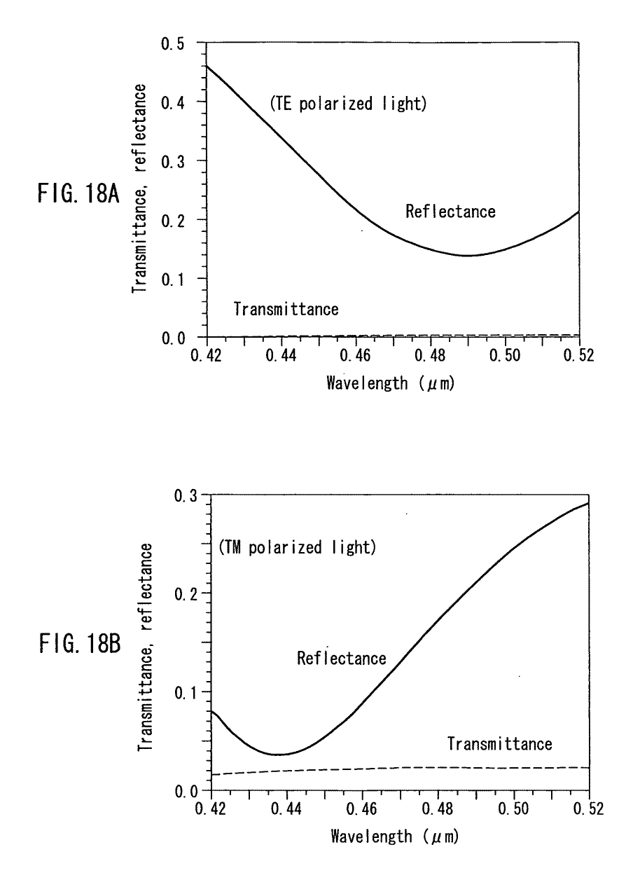

FIGS. 18A and 18B show a reflectance and a transmittance of the transmission type polarizing element of Reference Example 2 for the TE polarized light and the TM polarized light, respectively. The incident energy except for reflection and transmission was absorbed by the thin film 10 made of a light absorbing substance.

For example, at a wavelength of 0.47 μm,

TE polarized light: a reflectance of 18%; a transmittance of 0.13% (the remainder was absorbed) and

TM polarized light: a reflectance of 13%; a transmittance of 2.1% (the remainder was absorbed). Accordingly, the polarization extinction ratio of the transmitted light is 16.

The transmittance of the transmission type polarizing element for the TM polarizing component was even lower in Reference Example 2 than in Reference Example 1. Therefore, the transmission type polarizing element of Reference Example 2 is not suitable for the use of a polarizing plate at all.

### Design Example 6

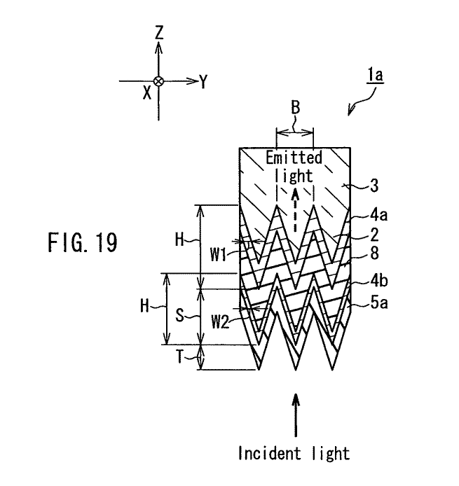

The transmission type polarizing element 1a shown in FIG. 19 (see Embodiment 3 (FIG. 3)) was defined as follows.

(A) Refractive index of the dielectric substrate 3: 1.45

(B) Base of the angle section of the dielectric substrate 3: B=180 nm (equal to the structural period in the Y-axis direction)

(C) Height of the angle section of the dielectric substrate 3: H=128 nm (the aspect ratio was 0.711)

(E1) Thickness of the first metal film 4a in the Y-axis direction: W1=4.0 nm

(E2) Thickness of the second metal film 4b in the Y-axis direction: W2=3.0 nm

(J) Space between the first and second metal films 4a, 4b in the Z-axis direction: S=100 nm

(K) Refractive index of the second dielectric substance layer 8: 1.45

(F) Complex refractive index of the first and second metal films 4a, 4b: n=2.91+4.07i (which is a constant value regardless of the frequency of light)

(G) Refractive index of the first dielectric substance layer 5a: 1.45

(H) Thickness of the first dielectric substance layer 5a in the Z-axis direction, measured from the top of the second metal film 4b: T=95 nm

In this example, the parameters W1, W2, S, and T were set so as to reduce the reflected light.

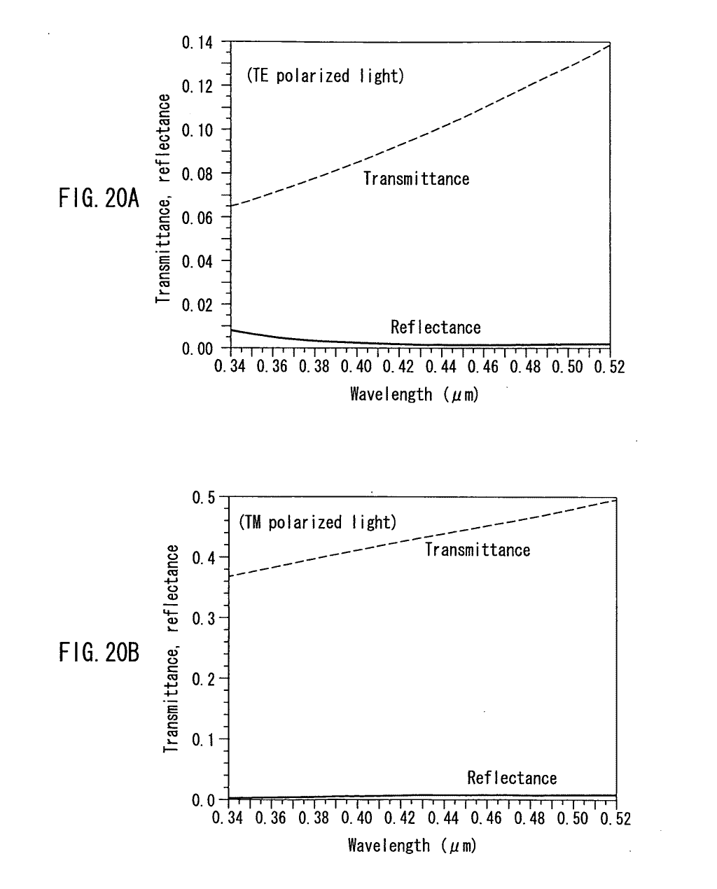

FIGS. 20A and 20B show a reflectance and a transmittance of the transmission type polarizing element 1a of Design Example 6 for the TE polarized light and the TM polarized light, respectively. The wavelength of light used was 0.34 μm to 0.52 μm. The incident energy except for reflection and transmission was absorbed by the first and second metal films 4a, 4b.

For example, at a wavelength of 0.42 μm,

TE polarized light: a reflectance of 0.17%; a transmittance of 9.2% (the remainder was absorbed) and

TM polarized light: a reflectance of 0.51%; a transmittance of 43% (the remainder was absorbed). Accordingly, the polarization extinction ratio of the transmitted light is 4.7. The extinction ratio is small for the transmission type polarizing element 1a of Design Example 6 to be used alone as a polarizing plate. Therefore, as shown in FIG. 4, the transmission type polarizing element 1a should be combined with another transmission type polarizing element. The reflectance is suppressed to a very low value, as described in Embodiment 3.

### Design Example 7

Using the transmission type polarizing element in FIG. 5, the following optimization design was performed to increase the extinction ratio in a wavelength region of 0.44 μm to 0.50 μm (blue). In this design example, the number of H layers was one.

(A) Refractive index of the dielectric substrate 3: 1.45

(B) Base of the angle section of the dielectric substrate 3: B=288.0 nm (equal to the structural period in the Y-axis direction)

(C′) Aspect ratio of the angle section of the dielectric substrate 3: 0.50

(α) Refractive index of the high refractive index layer (H layer): 2.10

(β) Refractive index of the low refractive index layer (L layer): 1.45

(E) Thickness of the metal film (i.e., the thin film made of a light absorbing substance) 4c in the Y-axis direction: W=3 nm

(F) Complex refractive index of the metal film (i.e., the thin film made of a light absorbing substance) 4c: the measured values of a Ge thin film at a wavelength of 510 nm (n=4.721 and k=2.189)

(G) Refractive index of the first dielectric substance layer 5b: 1.45

(I′) Physical thickness of each dielectric layer in the Z-axis direction

(Substrate Side)
H layer: 208.2 nm
L layer: 153.4 nm

(Metal Film Layer)
L layer: 92.8 nm

(Air Side)

Table 1 shows the complex refractive index of the Ge thin film.

TABLE 1

| Wavelength (nm) | n | k |
|---|---|---|
| 300 | 2.621 | 3.266 |
| 310 | 2.815 | 3.323 |
| 320 | 3.003 | 3.330 |
| 330 | 3.190 | 3.322 |
| 340 | 3.356 | 3.277 |
| 350 | 3.513 | 3.231 |
| 360 | 3.649 | 3.162 |
| 370 | 3.774 | 3.097 |
| 380 | 3.882 | 3.025 |
| 390 | 3.977 | 2.948 |
| 400 | 4.066 | 2.885 |
| 410 | 4.144 | 2.815 |
| 420 | 4.217 | 2.747 |
| 430 | 4.288 | 2.690 |
| 440 | 4.354 | 2.627 |
| 450 | 4.416 | 2.561 |
| 460 | 4.477 | 2.501 |
| 470 | 4.535 | 2.444 |
| 480 | 4.587 | 2.377 |
| 490 | 4.635 | 2.310 |
| 500 | 4.680 | 2.247 |
| 510 | 4.721 | 2.189 |
| 520 | 4.756 | 2.127 |
| 530 | 4.787 | 2.062 |
| 540 | 4.815 | 2.001 |
| 550 | 4.840 | 1.947 |
| 560 | 4.862 | 1.898 |
| 570 | 4.882 | 1.847 |
| 580 | 4.901 | 1.796 |
| 590 | 4.918 | 1.746 |
| 600 | 4.935 | 1.701 |
| 610 | 4.952 | 1.659 |
| 620 | 4.969 | 1.622 |
| 630 | 4.986 | 1.583 |
| 640 | 5.002 | 1.542 |
| 650 | 5.018 | 1.499 |
| 660 | 5.034 | 1.456 |
| 670 | 5.050 | 1.415 |
| 680 | 5.065 | 1.375 |
| 690 | 5.079 | 1.337 |
| 700 | 5.092 | 1.299 |
| 710 | 5.104 | 1.259 |
| 720 | 5.114 | 1.218 |
| 730 | 5.123 | 1.175 |
| 740 | 5.131 | 1.131 |
| 750 | 5.137 | 1.087 |
| 760 | 5.142 | 1.044 |
| 770 | 5.145 | 1.002 |
| 780 | 5.146 | 0.961 |
| 790 | 5.146 | 0.923 |
| 800 | 5.145 | 0.887 |
| 810 | 5.142 | 0.852 |
| 820 | 5.138 | 0.819 |
| 830 | 5.133 | 0.787 |
| 840 | 5.127 | 0.758 |
| 850 | 5.121 | 0.731 |
| 860 | 5.114 | 0.704 |
| 870 | 5.105 | 0.675 |
| 880 | 5.095 | 0.647 |
| 890 | 5.085 | 0.617 |
| 900 | 5.074 | 0.588 |
| 910 | 5.062 | 0.558 |
| 920 | 5.050 | 0.528 |
| 930 | 5.037 | 0.498 |
| 940 | 5.024 | 0.473 |
| 950 | 5.010 | 0.450 |
| 960 | 4.997 | 0.428 |
| 970 | 4.984 | 0.407 |
| 980 | 4.971 | 0.388 |
| 990 | 4.958 | 0.369 |
| 1000 | 4.945 | 0.352 |

In Table 1, n represents a refractive index and k represents an extinction coefficient.

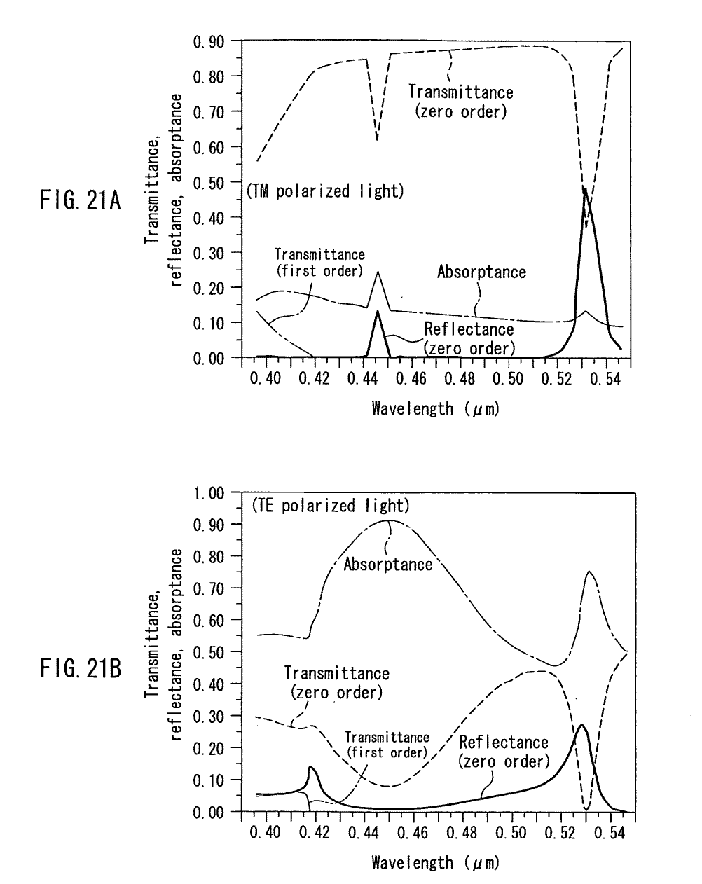

FIGS. 21A and 21B show a transmittance, a reflectance, and an absorptance for the TM polarized light and the TE polarized light, respectively, when light having a wavelength of 0.40 μm to 0.54 μm in a vacuum was incident perpendicularly from the air side on the transmission type polarizing element of Design Example 7. Compared to Reference Example 3 below, the transmittance for the TM polarized light is almost unchanged in a wavelength region of 0.45 μm to 0.51 μm, while the transmittance for the TE polarized light is minimized in the vicinity of a wavelength of 0.45 μm, and also is far smaller than that of Reference Example 3. Thus, it is clear that the extinction ratio is improved. This is the effect obtained by providing a reflection layer formed of the dielectric multi-layer film 10 on the dielectric substrate 3 side.

### Reference Example 3

To compare Reference Example 3 with Design Example 7, the following optimization design was performed to remove the H layer and the L layer (i.e., the dielectric multi-layer film) and increase the extinction ratio in a wavelength region of 0.44 μm to 0.50 μm (blue). The items other than the following are the same as those of Design Example 7.

(B) Base of the angle section of the dielectric substrate 3: B=288.4 nm (equal to the structural period in the Y-axis direction)

(I′) Physical thickness of each dielectric layer in the Z-axis direction

(Substrate Side)

(Metal Film Layer)
L layer: 113.5 nm

(Air Side)

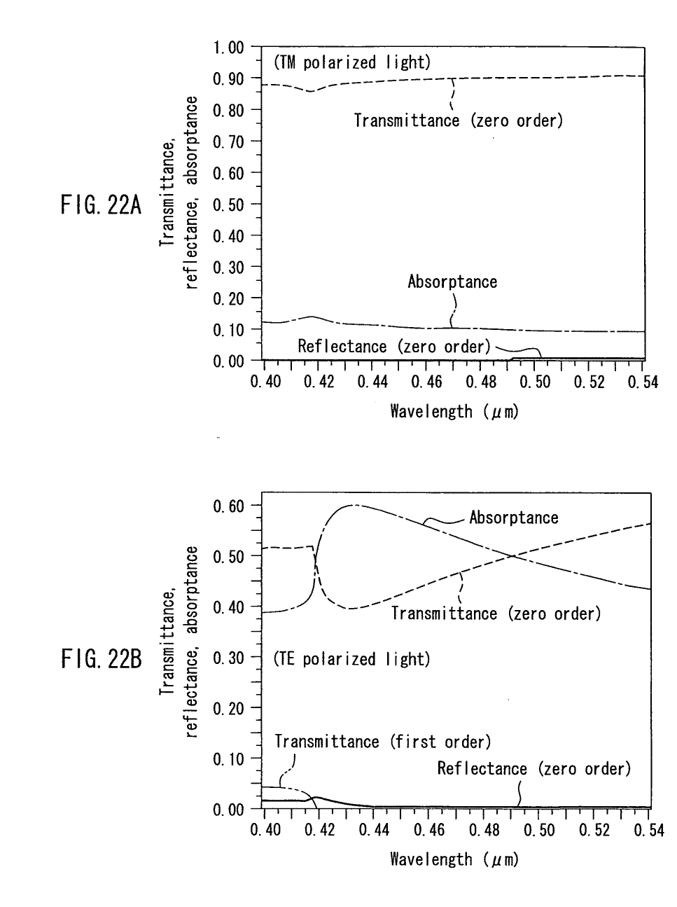

FIGS. 22A and 22B show a transmittance, a reflectance, and an absorptance for the TM polarized light and the TE polarized light, respectively, when light having a wavelength of 0.40 μm to 0.54 μm in a vacuum was incident perpendicularly from the air side on the transmission type polarizing element of Reference Example 3. In this reference example, no reflection layer formed of the dielectric multi-layer film is provided, and thus the minimization of the transmittance for the TE polarized light, as shown in Design Examples 7 and 8, does not appear.

### Design Example 8

Using the transmission type polarizing element in FIG. 5, the following optimization design was performed to increase the extinction ratio in a wavelength region of 0.43 μm to 0.50 μm (blue). The items other than the following are the same as those of Design Example 7. The number of H layers was one in Design Example 7, but two in this design example.

(B) Base of the angle section of the dielectric substrate 3: B=295.4 nm (equal to the structural period in the Y-axis direction)

(I′) Physical thickness of each dielectric layer in the Z-axis direction

(Substrate Side)
H layer: 189.6 nm
L layer: 122.0 nm
H layer: 188.7 nm
L layer: 193.0 nm

(Metal Film Layer)
L layer: 91.4 nm

(Air Side)

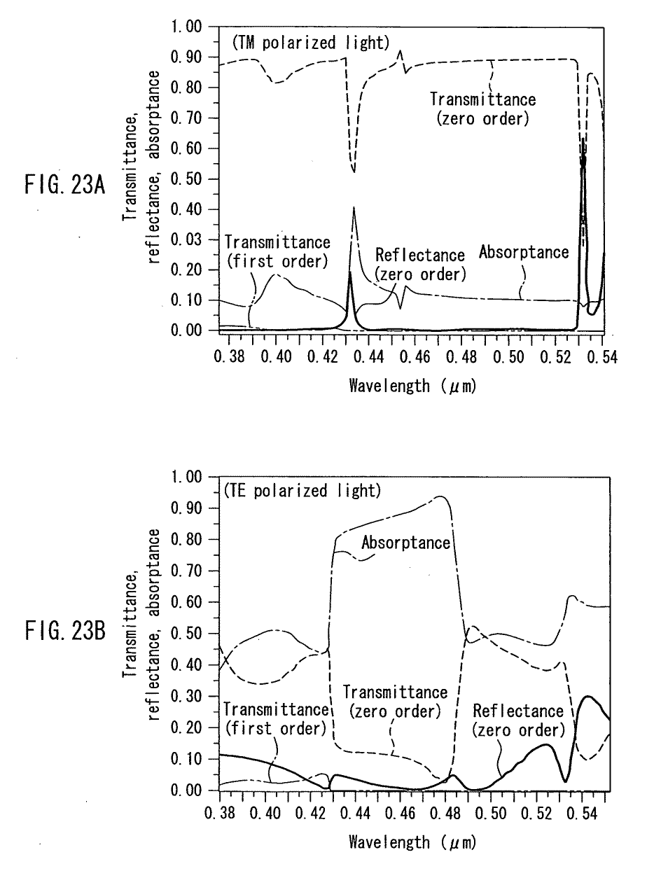

FIGS. 23A and 23B show a transmittance, a reflectance, and an absorptance for the TM polarized light and the TE polarized light, respectively, when light having a wavelength of 0.38 μm to 0.55 μm in a vacuum was incident perpendicularly from the air side on the transmission type polarizing element of Design Example 8. In this design example, the dielectric multi-layer film 10 includes two H layers, and thus the transmittance for the TE polarized light in a wavelength region of 0.43 μm to 0.48 μm is even smaller than that of Design Example 7.

### Design Example 9

The transmission type polarizing element shown in FIG. 7 was defined as follows. The metal film (i.e., the thin film made of a light absorbing substance) 4e was interposed between the L layers, and the number of H layers was two on the substrate side and one on the air side (incident side). The items other than the following are the same as those of Design Example 7.

(B) Base of the angle section of the dielectric substrate 3: B=292.0 nm (equal to the structural period in the Y-axis direction)

(I′) Physical thickness of each dielectric layer in the Z-axis direction

(Substrate Side)
H layer: 171.9 nm
L layer: 233.3 nm
H layer: 26.0 nm
L layer: 188.7 nm

(Metal Film Layer)
L layer: 17.1 nm
H layer: 104.0 nm
L layer: 94.5 nm

(Air Side)

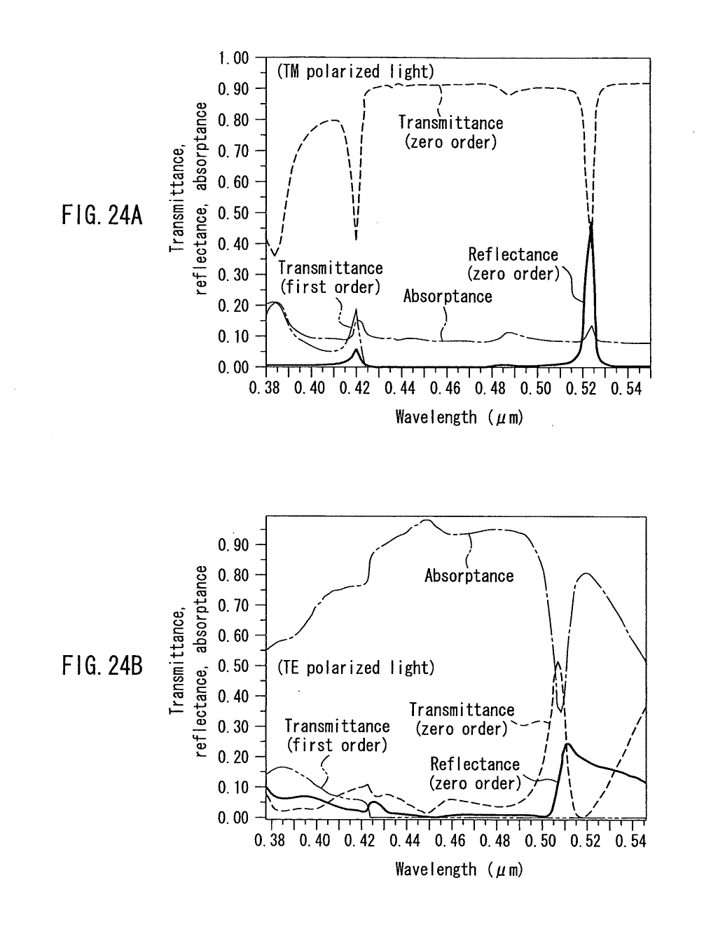

FIGS. 24A and 24B show a transmittance, a reflectance, and an absorptance for the TM polarized light and the TE polarized light, respectively, when light having a wavelength of 0.38 μm to 0.54 μm in a vacuum was incident perpendicularly from the air side on the transmission type polarizing element of Design Example 9. Compared to Design Example 8, the transmittance for the TE polarized light is reduced further, and the extinction ratio is improved.

### Example 1

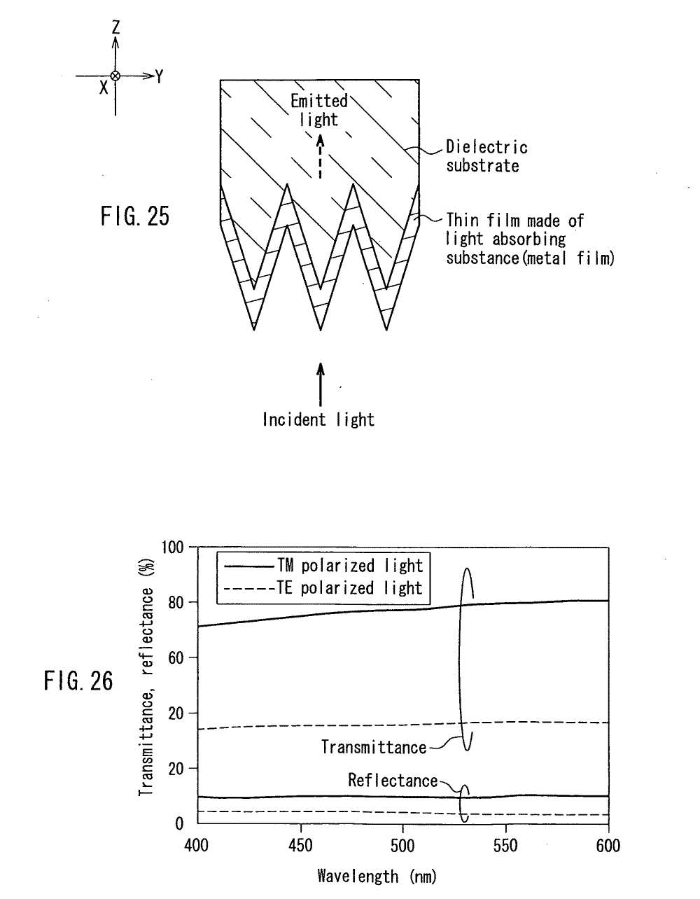

As shown in FIG. 25, a transmission type polarizing element including: a dielectric substrate having a structure in which a plurality of ridges with a triangular cross section are arranged parallel to each other on one side of the dielectric substrate; and a single thin film that is made of a light absorbing substance (metal film) and formed on the surfaces of the plurality of ridges with a triangular cross section was produced, and the properties of this transmission type polarizing element were evaluated. Cr was used as a material of the thin film made of a light absorbing substance (metal film). The details of the transmission type polarizing element will be described below.

First, a line-and-space Cr mask having a period of 200 nm was patterned on a quartz substrate by a lithography technology. Then, the quartz substrate was etched by dry etching using a fluorine-based gas. In this case, the plurality of periodically arranged ridges with a triangular cross section (i.e., the angle structure) was formed by optimizing the etching conditions such as the gas flow rate and the RF power. Subsequently, a Cr film serving as the thin film made of a light absorbing substance (metal film) was formed on the surface of the angle structure of the quartz substrate using a RF sputtering apparatus.

Next, a transmission spectrum and a reflection spectrum were measured with a spectrophotometer, and the polarization properties of the transmission type polarizing element were evaluated (this is also the same in the following examples).

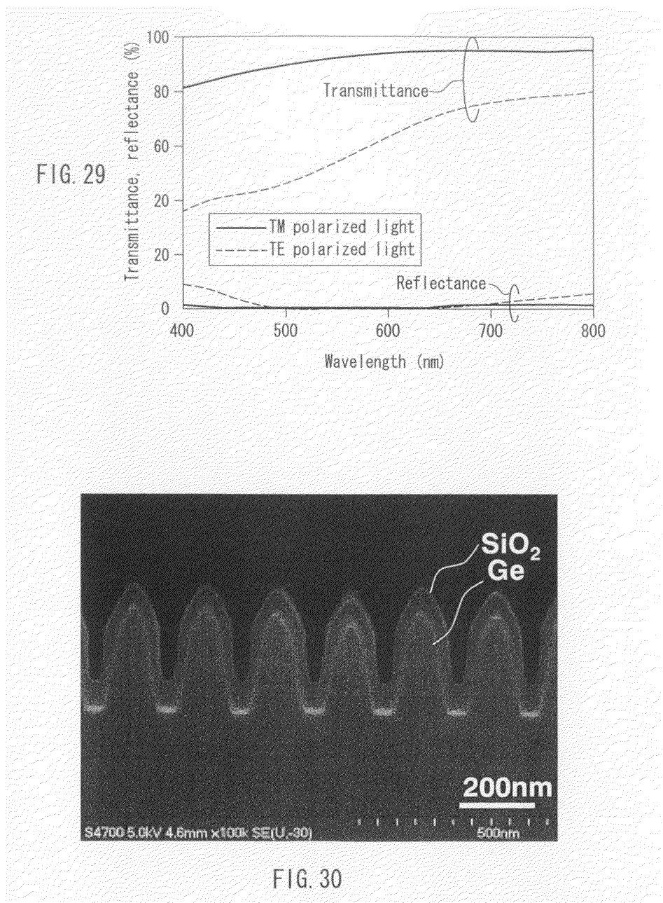

FIG. 26 shows the measured spectra, and Table 2 shows the characteristic values at representative wavelengths. In FIG. 26, the solid lines indicate a transmittance and a reflectance for the TM polarized light, while broken lines indicate a transmittance and a reflectance for the TE polarized light (this is also the same in FIGS. 29, 31, and 32).

TABLE 2

| | TM polarized light | | TE polarized light | | |
|---|---|---|---|---|---|
| | Transmit- | Reflec- | Transmit- | Reflec- | Extinction |
| Wavelength | tance (%) | tance (%) | tance (%) | tance (%) | ratio (dB) |
| 420 nm | 72.7 | 4.8 | 34.9 | 9.5 | 3.2 |
| 530 nm | 78.9 | 4.7 | 37.2 | 10.5 | 3.3 |
| 580 nm | 80.7 | 4.4 | 37.8 | 10.9 | 3.3 |

It is clear from FIG. 26 and Table 2 that the transmittance for the TE polarized light is lower than that for the TM polarized light, and the transmission type polarizing element functions as a polarizing element. Moreover, the extinction ratio remains flat (about 3 dB) in the wavelength region ranging from 400 nm to 600 nm.

### Example 2

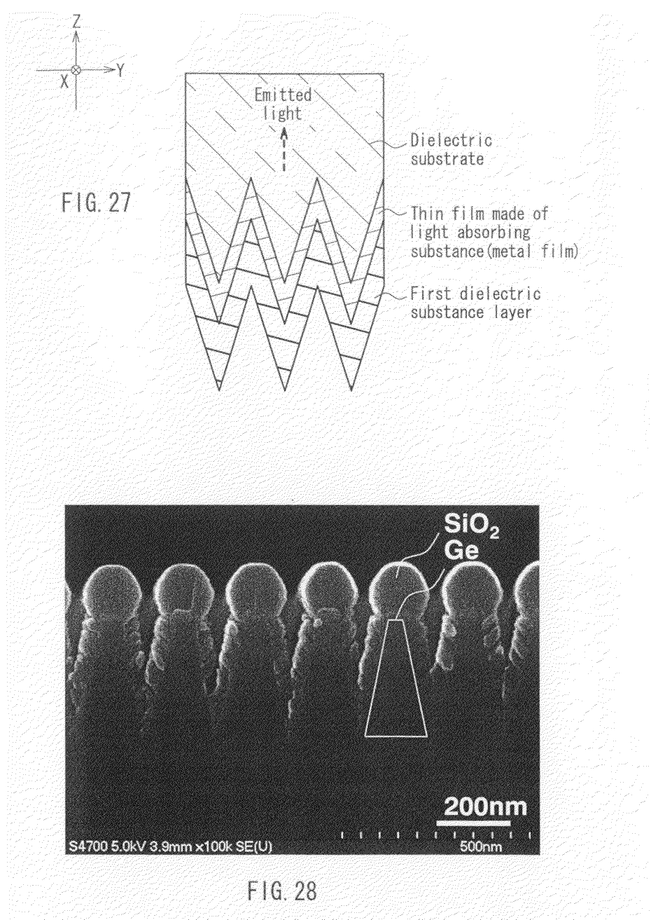

As shown in FIG. 27, a transmission type polarizing element including: a dielectric substrate having a structure in which a plurality of ridges with a triangular cross section are arranged parallel to each other on one side of the dielectric substrate; a single thin film that is made of a light absorbing substance (metal film) and formed on the surfaces of the plurality of ridges with a triangular cross section; and a single first dielectric substance layer covering the surface of the thin film made of a light absorbing substance (metal film) was produced, and the properties of this transmission type polarizing element were evaluated. Ge was used as a material of the thin film made of a light absorbing substance (metal film). SiO₂ was used as a material of the first dielectric substance layer. The details of the transmission type polarizing element will be described below.

First, in the similar manner to Example 1, an angle structure (i.e., the plurality of ridges with a triangular cross section) was formed on a quartz substrate. Subsequently, a Ge film serving as the thin film made of a light absorbing substance (metal film) was formed on the surface of the angle structure of the quartz substrate using a RF sputtering apparatus. Then, a SiO₂ film was formed on the Ge film using the same RF sputtering apparatus.

Next, the cross section of the transmission type polarizing element thus produced was observed with a scanning electron microscope (SEM). FIG. 28 shows a scanning electron micrograph of the cross section of the transmission type polarizing element. It is clear from FIG. 28 that the Ge film with a thickness of about several nm to 20 nm and the SiO₂ film with a thickness of 50 nm to 130 nm are formed on the surfaces of the plurality of periodically arranged ridges with a triangular cross section.

FIG. 29 shows the measured spectra, and Table 3 shows the characteristic values at representative wavelengths.

TABLE 3

| | TM polarized light | | TE polarized light | | |
|---|---|---|---|---|---|
| | Transmit- | Reflec- | Transmit- | Reflec- | Extinction |
| Wavelength | tance (%) | tance (%) | tance (%) | tance (%) | ratio (dB) |
| 420 nm | 80.4 | 0.63 | 38.0 | 8.0 | 3.3 |
| 530 nm | 88.2 | 0.59 | 49.9 | 0.4 | 2.5 |
| 580 nm | 90.3 | 0.55 | 58.6 | 0.27 | 1.9 |

As is evident from FIG. 29 and Table 3, the reflectance is reduced significantly compared to Example 1. This is due to the antireflection effect of the first dielectric substance layer (SiO₂ film) formed on the thin film made of a light absorbing substance (Ge film).

### Example 3

Like Example 2, a transmission type polarizing element including: a dielectric substrate having a structure in which a plurality of ridges with a triangular cross section are arranged parallel to each other on one side of the dielectric substrate; a single thin film that is made of a light absorbing substance (metal film) and formed on the surfaces of the plurality of ridges with a triangular cross section; and a single first dielectric substance layer covering the surface of the thin film made of a light absorbing substance (metal film) was produced. Ge was used as a material of the thin film made of a light absorbing substance (metal film). SiO₂ was used as a material of the first dielectric substance layer. The details of the transmission type polarizing element will be described below.

First, in the similar manner to Example 1, an angle structure (i.e., the plurality of ridges with a triangular cross section) was formed on a quartz substrate. Subsequently, a Ge film serving as the thin film made of a light absorbing substance (metal film) was formed on the surface of the angle structure of the quartz substrate using a RF sputtering apparatus. Then, a SiO₂ film was formed on the Ge film using a chemical vapor deposition (CVD) apparatus.

Next, the cross section of the transmission type polarizing element thus produced was observed with a scanning electron microscope (SEM). FIG. 30 shows a scanning electron micrograph of the cross section of the transmission type polarizing element. It is clear from FIG. 30 that the Ge film with a thickness of about several nm to 20 nm and the SiO₂ film with a thickness of 50 nm are formed on the surfaces of the plurality of periodically arranged ridges with a triangular cross section. The CVD method is more preferable than the physical deposition method (sputtering, vapor deposition, ion plating, etc.) as will be described in Design Example 11, since it has the advantage of achieving better step coverage and a uniform coating layer.

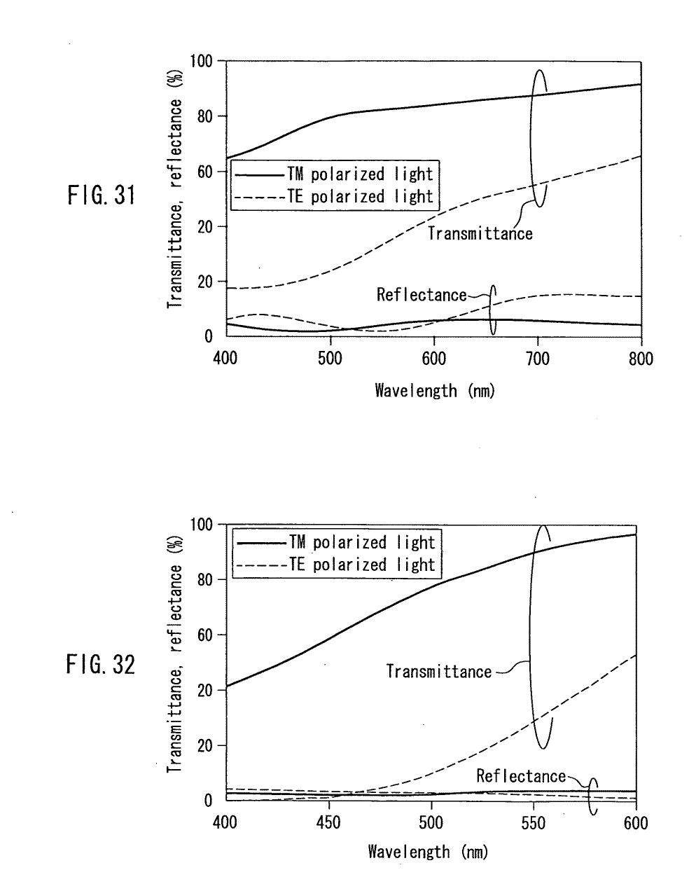

FIG. 31 shows the measured spectra, and Table 4 shows the characteristic values at representative wavelengths (before a heat treatment).

TABLE 4

| | | TM polarized light | | TE polarized light | | |
|---|---|---|---|---|---|---|
| | | Transmit- | Reflec- | Transmit- | Reflec- | Extinction |
| | Wavelength | tance (%) | tance (%) | tance (%) | tance (%) | ratio (dB) |
| Before | 420 nm | 67.6 | 4.0 | 18.4 | 7.9 | 5.7 |
| heat | 530 nm | 81.8 | 3.7 | 30.3 | 3.0 | 4.3 |
| treatment | 580 nm | 83.9 | 5.6 | 40.7 | 4.2 | 3.1 |
| After | 420 nm | 67.9 | 4.0 | 18.4 | 7.9 | 5.7 |
| heat | 530 nm | 82.0 | 3.8 | 30.6 | 2.9 | 4.3 |
| treatment | 580 nm | 84.1 | 5.7 | 41.1 | 4.3 | 3.1 |

As shown in FIG. 31 and Table 4, the extinction ratio of the transmission type polarizing element of this example is increased because the thin film made of a light absorbing substance (Ge film) is relatively thick.

Moreover, the transmission type polarizing element composed only of the inorganic materials in this example has higher heat resistance than that of a conventional organic film polarizing element. Therefore, the transmission type polarizing element of this example was heat-treated, and changes in the properties before and after the heat treatment were evaluated. Specifically, the transmission type polarizing element of this example was heat-treated in a dry oven at 200° C. for 35 hours, and then a transmission spectrum and a reflection spectrum were measured. Table 4 also shows the characteristic values at representative wavelengths after the heat treatment. As shown in Table 4, the characteristic values are unchanged before and after the heat treatment, indicating that the heat resistance is very high. Thus, the transmission type polarizing element of this example can be used preferably for a projector, an optical memory head, etc. that are exposed to a high-power lamp or laser.

### Example 4

Like Example 2, a transmission type polarizing element including: a dielectric substrate having a structure in which a plurality of ridges with a triangular cross section are arranged parallel to each other on one side of the dielectric substrate; a single thin film that is made of a light absorbing substance (metal film) and formed on the surfaces of the plurality of ridges with a triangular cross section; and a single first dielectric substance layer covering the surface of the thin film made of a light absorbing substance (metal film) was produced. Si was used as a material of the thin film made of a light absorbing substance (metal film). SiO₂ was used as a material of the first dielectric substance layer. The details of the transmission type polarizing element will be described below.

First, in the similar manner to Example 1, an angle structure (i.e., the plurality of ridges with a triangular cross section) was formed on a quartz substrate. Subsequently, a Si film serving as the thin film made of a light absorbing substance (metal film) was formed on the surface of the angle structure of the quartz substrate using a RF sputtering apparatus. Then, a SiO₂ film was formed on the Si film using a chemical vapor deposition (CVD) apparatus.

FIG. 32 shows the measured spectra, and Table 5 shows the characteristic values at representative wavelengths (before a heat treatment).

TABLE 5

| | TM polarized light | | TE polarized light | | |
|---|---|---|---|---|---|
| | Transmit- | Reflec- | Transmit- | Reflec- | Extinction |
| Wavelength | tance (%) | tance (%) | tance (%) | tance (%) | ratio (dB) |
| 420 nm | 47.1 | 4.0 | 0.5 | 7.9 | 20.1 |
| 530 nm | 85.0 | 3.7 | 21.0 | 3.0 | 6.1 |
| 580 nm | 95.0 | 5.6 | 44.3 | 4.2 | 3.3 |

As shown in FIG. 32 and Table 5, the transmission type polarizing element of this example has a high extinction ratio, which is 20 dB particularly in the blue wavelength region. This is because the thin film made of a light absorbing substance (Si film) is relatively thick.

### Design Example 10

In Design Example 10, using the transmission type polarizing element including the multi-layer films disposed on both sides of the metal film (see FIG. 7), the optimization design was performed to increase the extinction ratio in a wavelength region of 0.43 μm to 0.51 μm (blue). In this design example, the number of H layers was one on the substrate side of the metal film and one on the air side (incident side) of the metal film. Table 6 shows detailed design values.

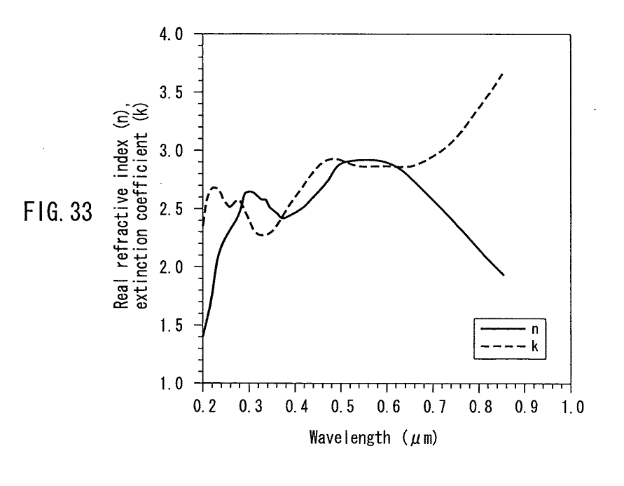

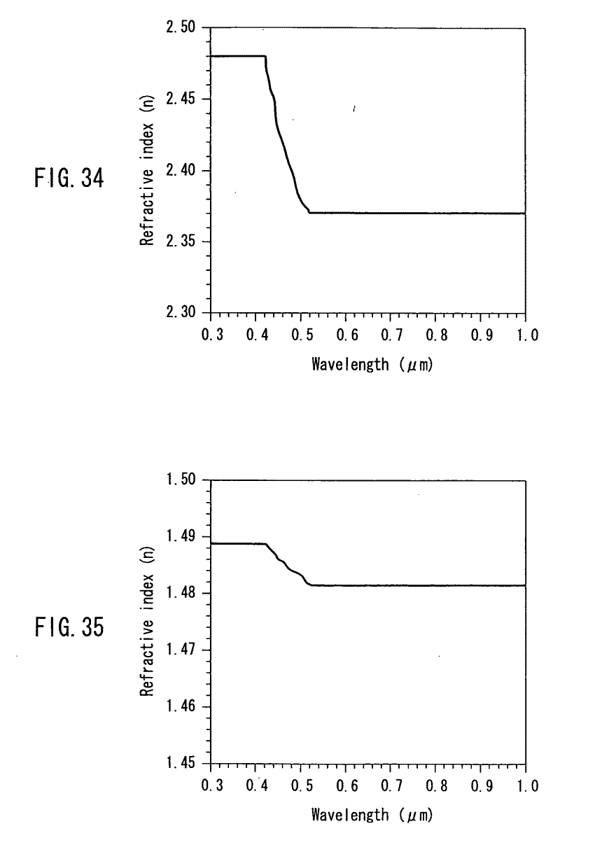

TABLE 6

| | Design | | Design | | Design | | Design | | Design | | Design | |
|---|---|---|---|---|---|---|---|---|---|---|---|---|
| | Example 10 | | Example 11 | | Example 12 | | Example 13 | | Example 14 | | Example 15 | |
| Refractive | the same | | the same | | the same | | 1.450 | | the same | | 1.620 | |
| index of | as L layer | | as L layer | | as L layer | | | | as L layer | | | |
| substrate | | | | | | | | | | | | |
| Period B | 292 nm | | 292 nm | | 292 nm | | 292 nm | | 292 nm | | 285.6 nm | |
| Aspect | 0.50 | | 0.70 | | 0.50 | | 0.50 | | 1.00 | | 0.50 | |
| ratio | | | | | | | | | | | | |
| Refractive | (FIG. 34) | | (FIG. 34) | | (FIG. 34) | | (FIG. 34) | | (FIG. 34) | | (FIG. 34) | |
| index of | | | | | | | | | | | | |
| H layer | | | | | | | | | | | | |
| Refractive | (FIG. 35) | | (FIG. 35) | | (FIG. 35) | | 1.620 | | (FIG. 35) | | 1.620 | |
| index of | | | | | | | | | | | | |
| L layer | | | | | | | | | | | | |
| Refractive | shown in | | shown in | | shown in | | shown in | | shown in | | shown in | |
| index of | (FIG. 33) | | (FIG. 33) | | (Table 1) | | (Table 1) | | (Table 1) | | (Table 1) | |
| metal film | | | | | | | | | | | | |
| Thickness | (Substrate) | | (Substrate) | | (Substrate) | | (Substrate) | | (Substrate) | | (Substrate) | |
| of each | H | 106.2 | H | 102.6 | Metal | 3.1 | Metal | 3.1 | Metal | 6.0 | Metal | 1.5 |
| layer in | layer | | layer | | film | | film | | film | | film | |
| Z-axis | L | 198.5 | L | 174.7 | L | 40.9 | L | 42.5 | L | 16.5 | L | 47.7 |
| direction | layer | | layer | | layer | | layer | | layer | | layer | |
| (nm) | Metal | 7.0 | Metal | 4.2 | H | 29.1 | H | 29.1 | H | 60.0 | Metal | 1.5 |
| | film | | film | | layer | | layer | | layer | | film | |
| | H | 113.9 | H | 89.9 | L | 120.1 | L | 117.5 | L | 137.6 | L | 58.7 |
| | layer | | layer | | layer | | layer | | layer | | layer | |

| | | | | | | | | |
|---|---|---|---|---|---|---|---|---|
| L | 90.4 | L | 88.0 | (Air) | (Air) | (Air) | Metal | 1.5 |
| layer | | layer | | | | | film | |

| | | | |
|---|---|---|---|
| (Air) | (Air) | L | 30.4 |
| | | layer | |
| | | Metal | 1.5 |
| | | film | |
| | | L | 0 |
| | | layer | |
| | | H | 86.1 |
| | | layer | |
| | | L | 75.6 |
| | | layer | |

(Air)

The refractive index (n+ki) of the metal film shown in FIG. 33 is the value of Nb described in the following document. The refractive indexes n shown in FIGS. 34 and 35 are based on the measured data of a SiO₂ film (H layer) and Nb₂O₅ film (L layer), respectively.

Document: “Handbook of Optical Constants of Solids II”, E. D. Palik, Academic Press (1991), pp 396-408

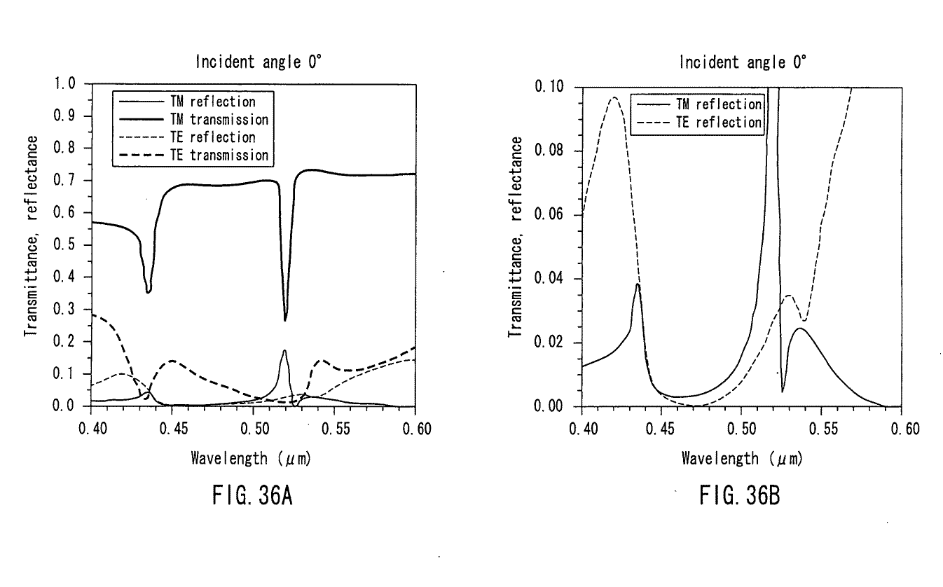

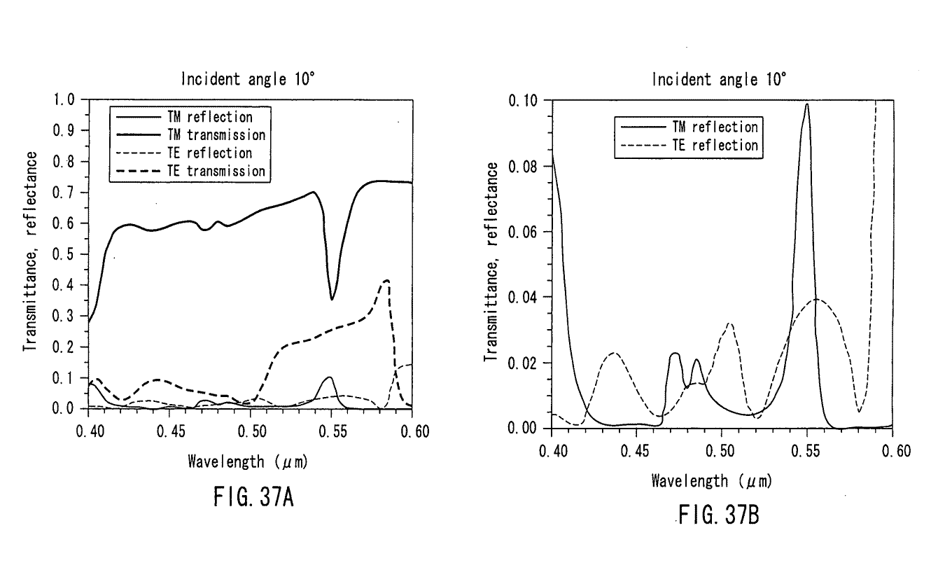

FIGS. 36 and 37 show a transmittance and a reflectance for the TM polarized light and the TE polarized light when light having a wavelength of 0.4 μm to 0.6 μm in a vacuum was incident from the air side on the transmission type polarizing element of Design Example 10. The incident angle θ is 0° in FIG. 36 and 10° in FIG. 37. In this case, the incident angle θ indicates an angle between the incident light and the Z axis (see FIG. 7). With respect to the reflectance, a partially enlarged graph is shown as B of each of the figures (this is also true for the graphs in the following Design Examples 11 to 14).

### Design Example 11

In Design Example 11, the aspect ratio was larger than that of Design Example 10.

Using the transmission type polarizing element having the configuration shown in FIG. 7, the optimization design was performed to increase the extinction ratio in a wavelength region of 0.43 μm to 0.51 μm (blue). In this design example, the number of H layers was one on the substrate side of the metal film and one on the air side (incident side) of the metal film. The incident light entered from the air side. Table 6 shows detailed design values.

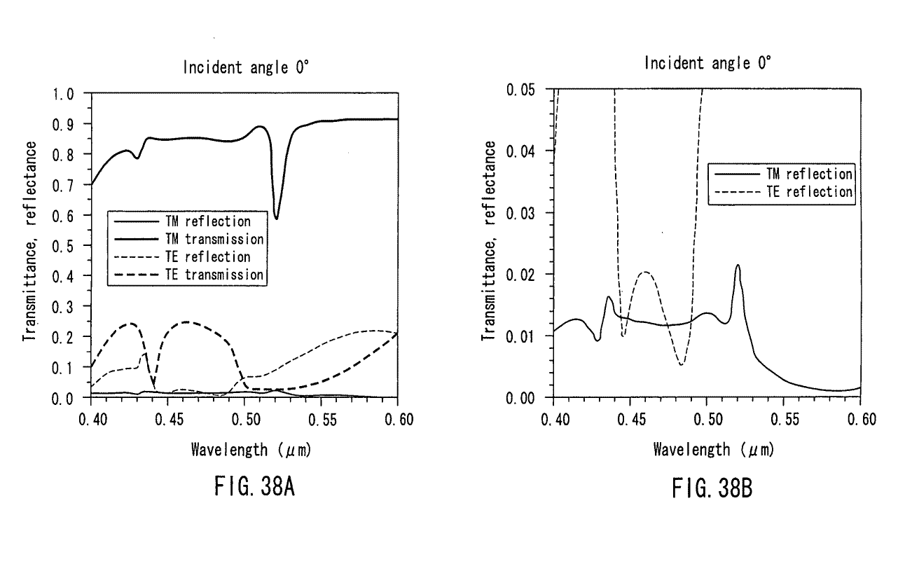

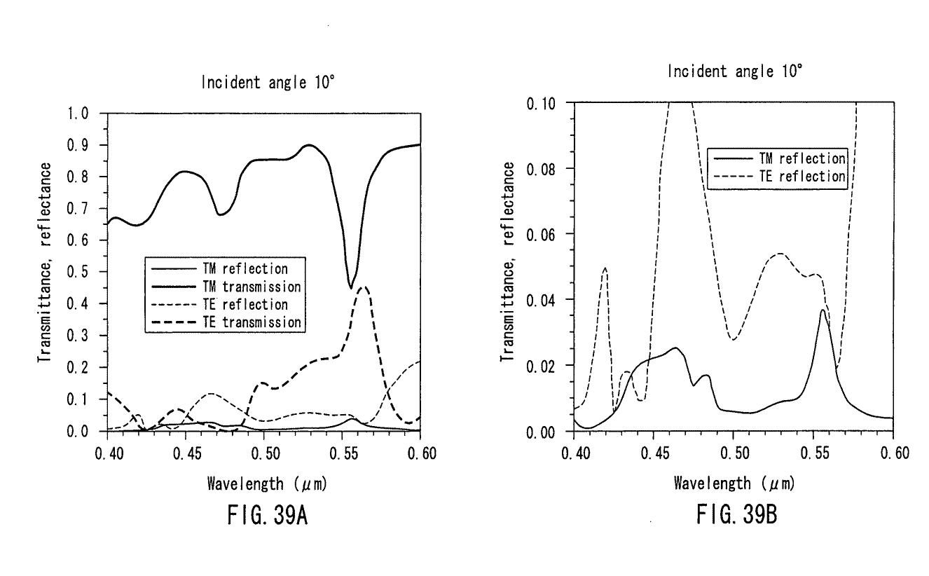

FIGS. 38 and 39 show a transmittance and a reflectance for the TM polarized light and the TE polarized light when light having a wavelength of 0.4 μm to 0.6 μm in a vacuum was incident from the air side on the transmission type polarizing element of Design Example 11.

### Design Example 12

Design Example 12 particularly focused on reducing the reflectance.

Using the transmission type polarizing element including the multi-layer film disposed on the air side of the metal film (see FIG. 6), the optimization design was performed to reduce the reflectance in a wavelength region of 0.42 μm to 0.52 μm (blue). In this design example, the number of H layers was one only on the air side. The incident light entered from the air side. Table 6 shows detailed design values.

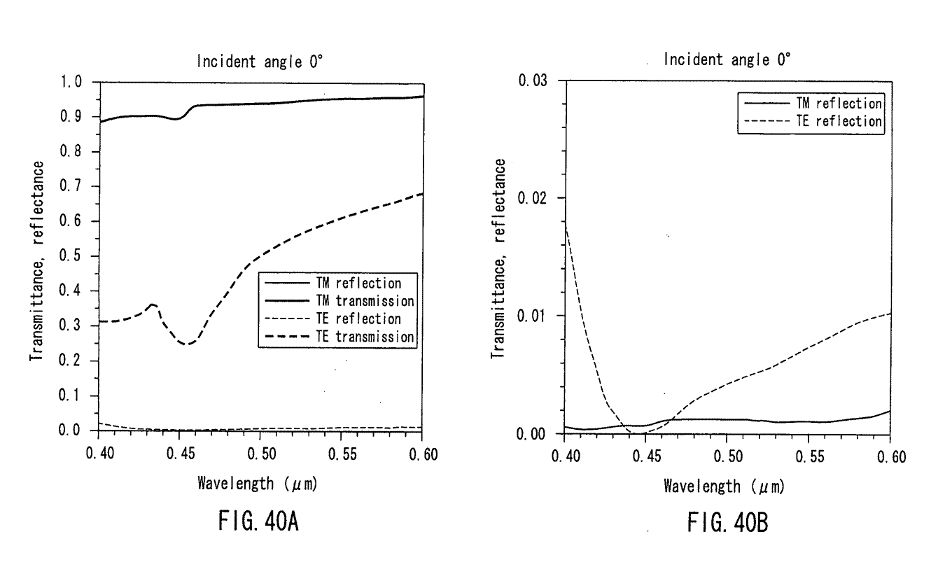

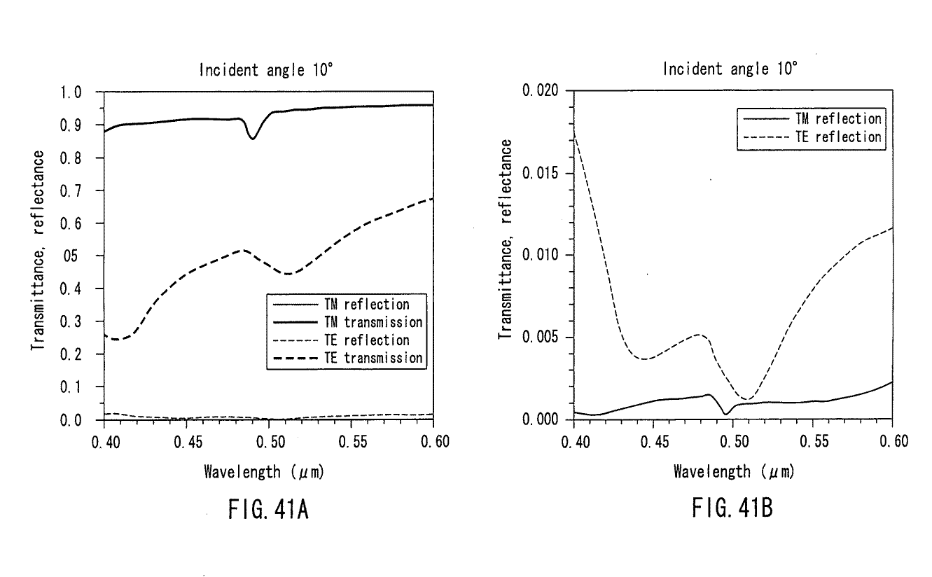

FIGS. 40 and 41 show a transmittance and a reflectance for the TM polarized light and the TE polarized light when light having a wavelength of 0.4 μm to 0.6 μm in a vacuum was incident from the air side on the transmission type polarizing element of Design Example 12.

### Design Example 13

Like Design Example 12, Design Example 13 focused on reducing the reflectance. The refractive index of the L layer was set to 1.62 regardless of the wavelength.

Using the transmission type polarizing element having the configuration shown in FIG. 6, the optimization design was performed to reduce the reflectance in a wavelength region of 0.42 μm to 0.52 μm (blue). In this design example, the number of H layers was one only on the air side. The incident light entered from the air side. Table 6 shows detailed design values.

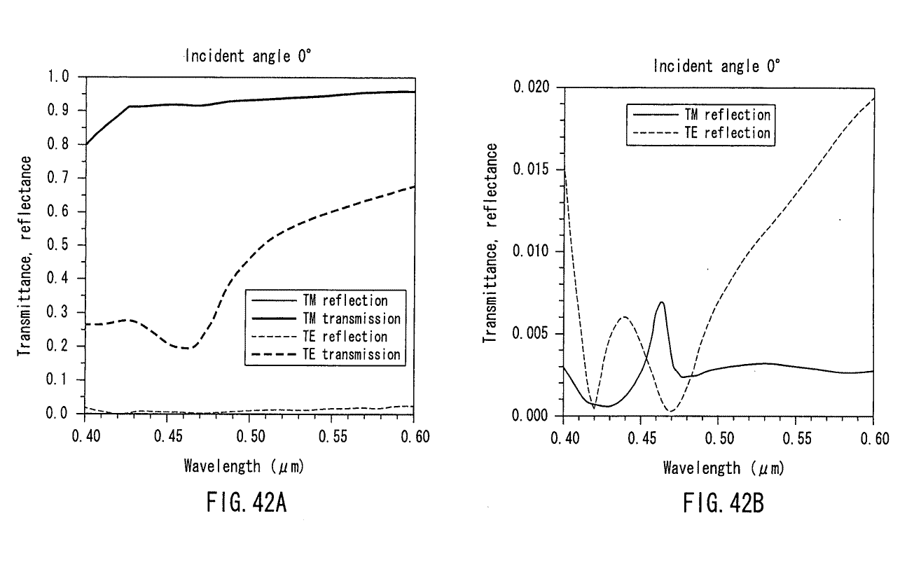

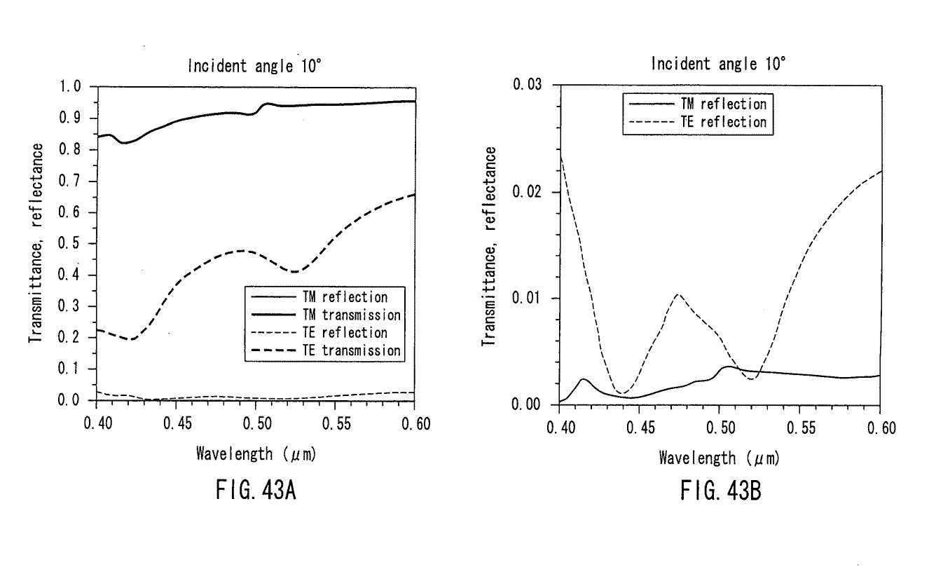

FIGS. 42 and 43 show a transmittance and a reflectance for the TM polarized light and the TE polarized light when light having a wavelength of 0.4 μm to 0.6 μm in a vacuum was incident from the air side on the transmission type polarizing element of Design Example 13.

### Design Example 14

Design Example 14 focused on reducing the reflectance by setting the aspect ratio A=1.0.

Using the transmission type polarizing element having the configuration shown in FIG. 6, the optimization design was performed to reduce the reflectance in a wavelength region of 0.42 μm to 0.52 μm (blue). In this design example, the number of H layers was one only on the air side. The incident light entered from the air side. Table 6 shows detailed design values.

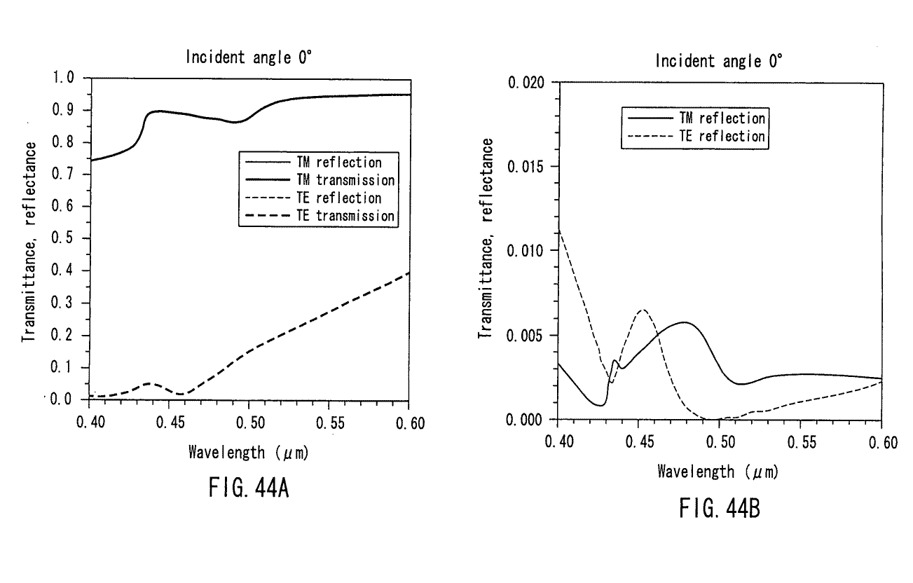

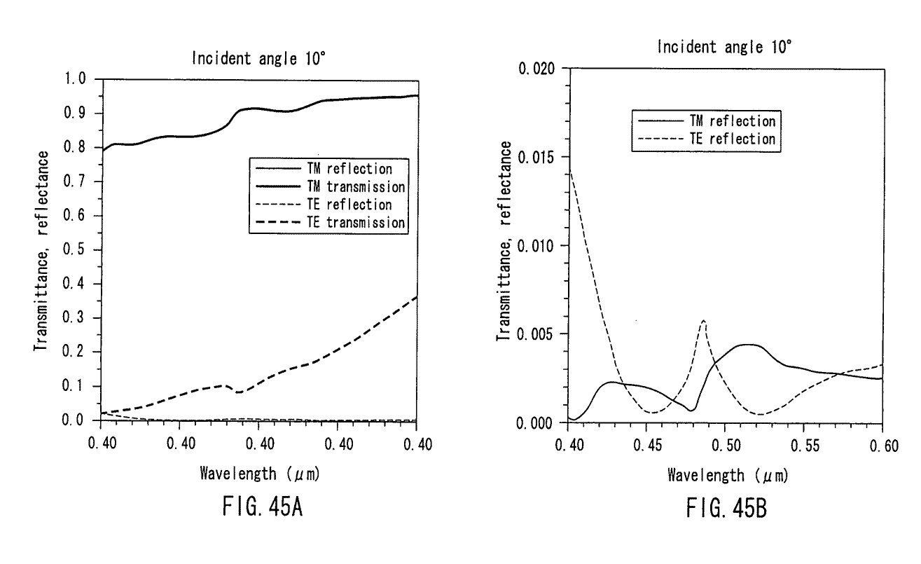

FIGS. 44 and 45 show a transmittance and a reflectance for the TM polarized light and the TE polarized light when light having a wavelength of 0.4 μm to 0.6 μm in a vacuum was incident from the air side on the transmission type polarizing element of Design Example 14.

### Design Example 15

In Design Example 15, the extinction ratio was improved by setting the aspect ratio A=0.5 and providing a multi-layer metal film. The refractive index of the L layer was set to 1.62 regardless of the wavelength.

The metal film of the transmission type polarizing element having the configuration shown in FIG. 6 was divided into four layers, and the optimization design was performed to reduce the reflectance in a wavelength region of 0.42 μm to 0.52 μm (blue). Each of the four metal films had a thickness of 1.5 nm, and the L layer was interposed between the metal films. In this design example, the number of H layers was one only on the air side. The incident light entered from the air side. Table 6 shows detailed design values.

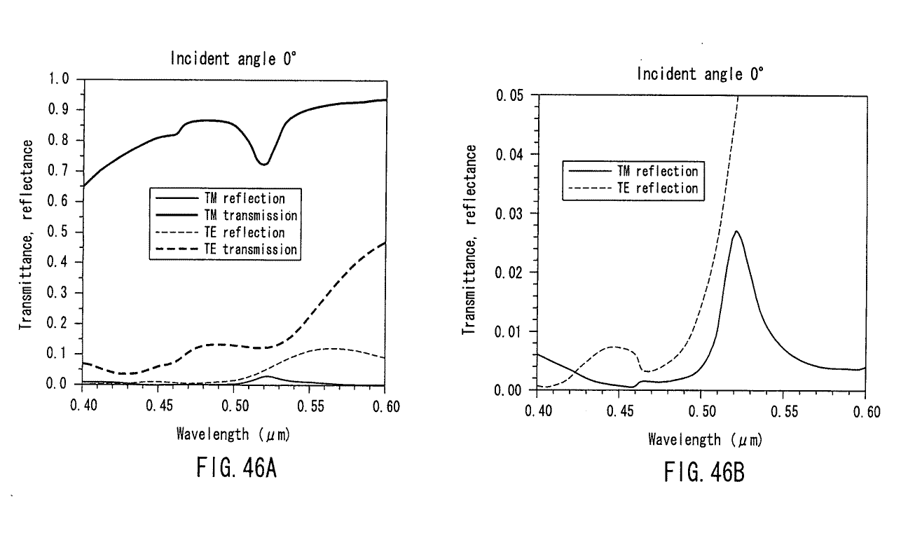

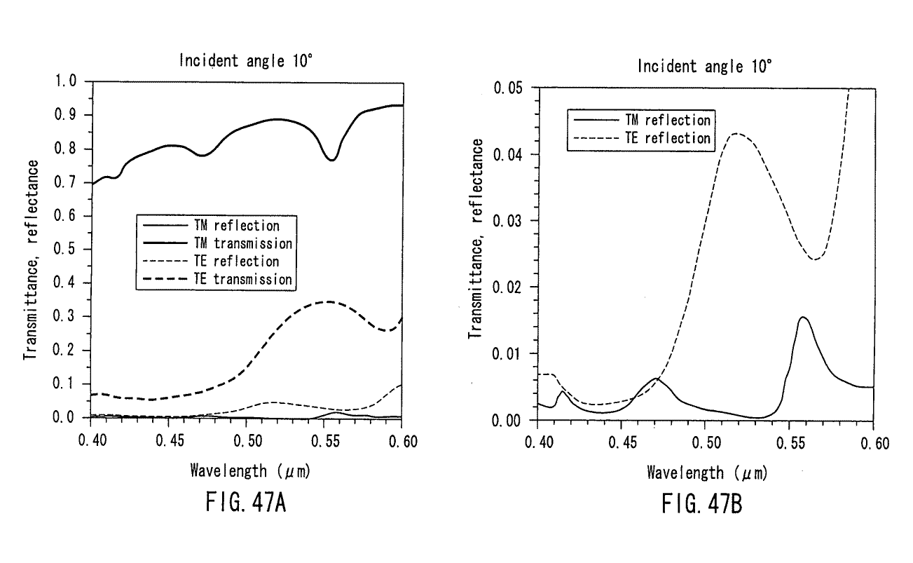

FIGS. 46 and 47 show a transmittance and a reflectance for the TM polarized light and the TE polarized light when light having a wavelength of 0.4 μm to 0.6 μm in a vacuum was incident from the air side on the transmission type polarizing element of Design Example 15.

### Example 5

In Example 5, a transmission type polarizing element including a metal film and a dielectric multi-layer film that have a triangular structure was produced based on Design Example 12, and the properties of this transmission type polarizing element were evaluated.

The manufacturing processes will be described below.

(1) First, a resist for an electron beam was applied on a quartz substrate (50 mm×50 mm, with a thickness of 1.5 mm) by spin coating. Next, the quartz substrate was baked with a hot plate and subjected to a conductive treatment by applying a conducting agent. Then, a pattern was printed on the quartz substrate using an electron-beam lithography apparatus. This quartz substrate was immersed successively in a developer and a rinse solution, thereby forming a periodic pattern of the resist including lines and spaces. The pattern area was 10 mm×10 mm, and the period of the pattern was 292 nm. This resist pattern was used as a mask (resist mask) for the subsequent dry etching. Next, the quartz substrate was processed by reactive dry etching using a fluorine-based gas, so that a convexo-concave structure with a rectangular cross section having a depth of 130 nm and a period of 292 nm was formed.

Next, this quartz substrate was exposed to oxygen plasma to remove the remaining resist mask. The reactive dry etching was further performed under the appropriate conditions, and thus the convexo-concave structure was shaped into a triangular cross section having a depth of 140 nm and a period of 292 nm.

(2) A Ge film was formed on the surface of the quartz substrate with a triangular cross section by an opposed type RF sputtering apparatus using Ge as a target. In this case, the sputtering time was adjusted so that the thickness of the Ge film was 3.1 nm in the direction perpendicular to the surface of the quartz substrate.

(3) A SiO₂ film (H layer), a Nb₂O₃ film (L layer), and a SiO₂ film (H layer) were formed in this order on the Ge film by an autocloning apparatus. In this case, the sputtering time was adjusted so that the thickness of each of the layers was the value described in Design Example 13 (see Table 6). An example of the autocloning apparatus is disclosed in the above-described Japanese Patent No. 3486334.

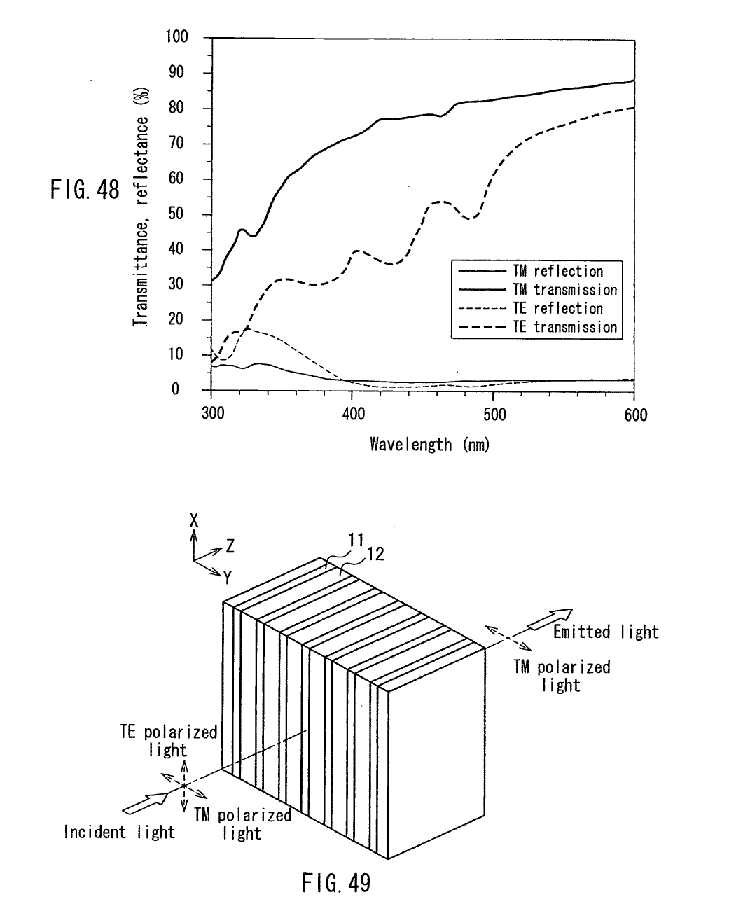

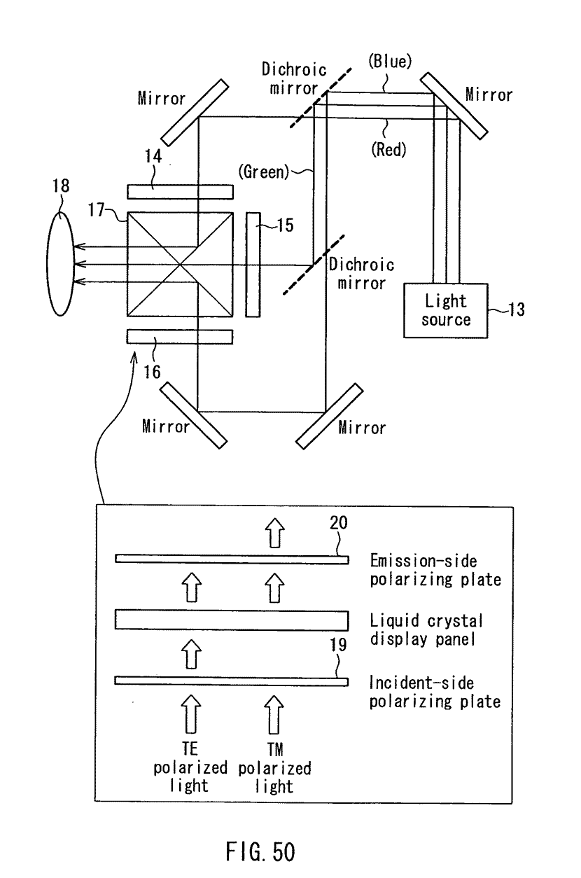

Light was incident on the surface of the transmission type polarizing element that faces the air side at an incident angle θ of 5°. Then, a transmission spectrum and a reflection spectrum were measured with a spectrophotometer, and the polarization properties of the transmission type polarizing element were evaluated. FIG. 48 shows the measured spectra. In FIG. 48, the solid lines indicate a transmittance and a reflectance for the TM polarized light, while broken lines indicate a transmittance and a reflectance for the TE polarized light. It is clear from FIG. 48 that the transmittance for the TE polarized light is lower than that for the TM polarized light, and the transmission type polarizing element functions as a polarizing element.

1. A transmission type polarizing element comprising:
a dielectric substrate having a structure in which a plurality of ridges with an angle section are arranged parallel to each other on one side of the dielectric substrate; and
a thin film that is made of a light absorbing substance and provided on the plurality of ridges with an angle section,
wherein when light is incident perpendicularly on the dielectric substrate, the transmission type polarizing element transmits a TM polarizing component of the incident light whose magnetic field vibrates in the same direction as a longitudinal direction of the ridges and absorbs a TE polarizing component of the incident light whose electric field vibrates in the same direction as the longitudinal direction of the ridges.

2. The transmission type polarizing element according to claim 1, wherein a surface of the thin film that faces away from the dielectric substrate is covered with a first dielectric substance layer.

3. The transmission type polarizing element according to claim 2, wherein a surface of the first dielectric substance layer that faces away from the dielectric substrate is a plane.

4. The transmission type polarizing element according to claim 2, wherein a surface of the first dielectric substance layer that faces away from the dielectric substrate has a shape that follows the angle section.

5. The transmission type polarizing element according to claim 1, wherein the plurality of ridges with an angle section are of the same cross-sectional shape and are arranged parallel to each other at a constant period.

6. The transmission type polarizing element according to claim 1, wherein a plurality of the thin films made of a light absorbing substance are disposed with a second dielectric substance layer interposed between them.

7. The transmission type polarizing element according to claim 1, wherein a dielectric multi-layer film having a shape that follows the angle section is disposed between the thin film made of a light absorbing substance and the dielectric substrate.

8. The transmission type polarizing element according to claim 2, wherein the first dielectric substance layer covering the surface of the thin film that faces away from the dielectric substrate is a dielectric multi-layer film having a shape that follows the angle section.

9. A composite polarizing plate comprising:
a first transmission type polarizing element disposed on a light incident side; and
a second transmission type polarizing element disposed on a light emitting side, wherein only the first transmission type polarizing element of the first and second transmission type polarizing elements is the transmission type polarizing element according to claim 1.
